(19) United States
(12) Patent Application Publication
(10) Pub. No.: US 2023/0046231 A1
(43) Pub. Date: Feb. 16, 2023

(54) DIFFERENT RELIABILITY LEVELS FOR ACKNOWLEDGEMENT/NEGATIVE ACKNOWLEDGEMENT (ACK/NACK) TRANSMISSIONS

(71) Applicant: QUALCOMM Incorporated, San Diego, CA (US)

(72) Inventors: Konstantinos DIMOU, New York City, NY (US); Yan ZHOU, San Diego, CA (US); Tao LUO, San Diego, CA (US); Xiaoxia ZHANG, San Diego, CA (US); Seyedkianoush HOSSEINI, San Diego, CA (US); Mostafa KHOSHNEVISAN, San Diego, CA (US); Sony AKKARAKARAN, Poway, CA (US); Jelena DAMNJANOVIC, Del Mar, CA (US); Arumugam CHENDAMARAI KANNAN, San Diego, CA (US); Kazuki TAKEDA, Tokyo (JP)

(21) Appl. No.: 17/759,148

(22) PCT Filed: Jan. 21, 2021
(86) PCT No.: PCT/US2021/014463

§ 371 Date: Jul. 20, 2022

(30) Foreign Application Priority Data
Jan. 21, 2020 (GR) 20200100027
Jan. 31, 2020 (GR) 20200100054

(51) Int. Cl. H04L 1/18

(52) U.S. Cl. CPC H04L 1/1861; H04L 1/1864

(57) ABSTRACT

Wireless communications systems and methods related to acknowledgement/negative-acknowledgement (ACK/NACK) transmissions with different reliability levels are provided. A user equipment (UE) receives, from a base station (BS), a negative acknowledgement (NACK) transmission configuration. The UE receives, from the BS, a data transmission. The UE transmits, to the BS, a physical uplink control channel (PUCCH) signal including a NACK for the data transmission based on the received NACK transmission configuration. Other aspects and features are also described.

### CROSS REFERENCE TO RELATED APPLICATIONS & PRIORITY CLAIM

The present application claims priority to and the benefit of Greek Patent Application No. 20200100027 filed Jan. 21, 2020 and Greek Patent Application No. 20200100054 filed Jan. 31, 2020, which are hereby incorporated by reference in their entirety as if fully set forth below and for all applicable purposes.

### TECHNICAL FIELD

The technology described below relates generally to wireless communication systems, and more particularly to acknowledgement/negative-acknowledgement (ACK/NACK) transmissions (e.g., hybrid automatic repeat request (HARQ) ACK/NACK). Certain embodiments can enable and provide techniques allowing communication devices (e.g., user equipment devices or base stations) to transmit a negative-acknowledgement (NACK) feedback with a higher transmission reliability than an acknowledgement (ACK) feedback.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 4^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

One approach to providing a high-reliability communication is to apply HARQ techniques. For example, a BS may transmit a downlink (DL) transmission to a UE and the UE may provide the BS with a reception status of the DL transmission. If the UE receives the DL transmission successfully, the UE may transmit a HARQ-acknowledgement (HARQ-ACK) to the BS. Conversely, if the UE fails to receive the DL transmission successfully, the UE may transmit a HARQ-negative-acknowledgement (HARQ-NACK) to the BS. Upon receiving a HARQ-NACK from the UE, the BS may retransmit the DL transmission. The BS may retransmit the DL transmission until a HARQ-ACK is received from the UE or reaching a certain retransmission limit.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects of the present disclosure enable and provide mechanisms and techniques enabling improved communication and operational performance. Such improvements may be brought about via disclosed aspects, embodiments, and techniques for transmitting negative-acknowledgement (NACK) feedbacks with a higher transmission reliability than acknowledgement (ACK) feedbacks. Such improvements may be brought about via disclosed aspects, embodiments, and techniques for providing and processing indications to change acknowledgement feedback modes.

For instance, a BS may configure a UE with a physical control channel (PUCCH) configuration for transmitting ACK/NACKs. The PUCCH configuration may include a NACK-specific transmission configuration for transmitting NACK transmissions with a higher transmission reliability than ACK transmissions. The NACK transmission configuration may configure the UE to boost transmit powers of NACK transmissions and/or apply multi-beams for NACK transmissions.

For example, in an aspect of the disclosure, a method of wireless communication, includes receiving, by a user equipment (UE) from a base station (BS), a negative acknowledgement (NACK) transmission configuration. The method may also include receiving, by the UE from the BS, a data transmission. The method may also include transmitting, by the UE to the BS, a physical uplink control channel (PUCCH) signal including a NACK for the data transmission based on the received NACK transmission configuration.

In an additional aspect of the disclosure, a method of wireless communication, includes transmitting, by a base station (BS) to a user equipment (UE), a negative acknowledgement (NACK) transmission configuration. The method may also include transmitting, by the BS to the UE, a data transmission. The method may also include receiving, by the BS from the UE, a physical uplink control channel (PUCCH) signal including a NACK for the data transmission based on the received NACK transmission configuration.

In an additional aspect of the disclosure, a user equipment (UE) includes a transceiver configured to receive, from a base station (BS), a negative acknowledgement (NACK) transmission configuration. The transceiver may also be configured to receive, from the BS, a data transmission. The transceiver may also be configured to transmit, to the BS, a physical uplink control channel (PUCCH) signal including a NACK for the data transmission based on the received NACK transmission configuration.

In an additional aspect of the disclosure, a base station (BS) includes a transceiver configured to transmit, to a user equipment (UE), a negative acknowledgement (NACK) transmission configuration. The transceiver may also be configured to transmit, to the UE, a data transmission. The transceiver may also be configured to receive, from the UE, a physical uplink control channel (PUCCH) signal including a NACK for the data transmission based on the received NACK transmission configuration.

In an additional aspect of the disclosure, a non-transitory computer-readable medium having program code recorded thereon, the program code includes code for causing a user equipment (UE) to receive, from a base station (BS), a negative acknowledgement (NACK) transmission configuration. The program code may also include code for causing the UE to receive, from the BS, a data transmission. The program code may also include code for causing the UE to transmit, to the BS, a physical uplink control channel (PUCCH) signal including a NACK for the data transmission based on the received NACK transmission configuration.

In an additional aspect of the disclosure, a non-transitory computer-readable medium having program code recorded thereon, the program code includes code for causing a base station (BS) to transmit, to a user equipment (UE), a negative acknowledgement (NACK) transmission configuration. The program code may also include code for causing the BS to transmit, to the UE, a data transmission. The program code may also include code for causing the BS to receive, from the UE, a physical uplink control channel (PUCCH) signal including a NACK for the data transmission based on the received NACK transmission configuration.

In an additional aspect of the disclosure, a user equipment (UE) includes means for receiving, from a base station (BS), a negative acknowledgement (NACK) transmission configuration. The UE may also include means for receiving, from the BS, a data transmission. The UE may also include means for transmitting, to the BS, a physical uplink control channel (PUCCH) signal including a NACK for the data transmission based on the received NACK transmission configuration.

In an additional aspect of the disclosure, a base station (BS) includes means for transmitting, to a user equipment (UE), a negative acknowledgement (NACK) transmission configuration. The BS may also include means for transmitting, to the UE, a data transmission. The BS may also include means for receiving, from the UE, a physical uplink control channel (PUCCH) signal including a NACK for the data transmission based on the received NACK transmission configuration.

Certain aspects provide a method for wireless communications by a user equipment. The method generally includes obtaining signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode and communicating with the network entity in accordance with the indicated acknowledgment feedback mode.

Certain aspects provide a method for wireless communications by a network entity. The method generally includes outputting, for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode and communicating with the UE in accordance with the indicated acknowledgment feedback mode.

Aspects of the present disclosure provide means for, apparatus, processors, and computer-readable mediums for performing the methods described herein.

Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates a hybrid automatic repeat request (HARQ) communication scenario according to embodiments of the present disclosure.

FIG. 4 is a block diagram of a user equipment (UE) according to some aspects of the present disclosure.

FIG. 5 is a block diagram of an exemplary base station (BS) according to some aspects of the present disclosure.

FIG. 6A is a signaling diagram illustrating a HARQ transmission method according to some aspects of the present disclosure.

FIG. 6B illustrates an uplink (UL) control channel resource configuration according to some aspects of the present disclosure.

FIG. 6C illustrates a HARQ acknowledgement/negative-acknowledgement (ACK/NACK) transmission scheme according to some aspects of the present disclosure.

FIG. 7A illustrates an uplink (UL) control channel configuration with a negative-acknowledgement (NACK)-specific transmit power configuration according to some aspects of the present disclosure.

FIG. 7B illustrates a UL control channel power control scheme according to some aspects of the present disclosure.

FIG. 7C illustrates a physical uplink control channel (PUCCH) power control information element 730 according to some aspects of the present disclosure.

FIG. 7D illustrates a PUCCH format configuration information element according to some aspects of the present disclosure.

FIG. 8A illustrates a UL control channel configuration with a negative-acknowledgement (NACK)-specific transmit power configuration according to some aspects of the present disclosure.

FIG. 8B illustrates a PUCCH power control set information element according to some aspects of the present disclosure.

FIG. 9A illustrates a UL control channel configuration with a NACK-specific transmit power configuration according to some aspects of the present disclosure.

FIG. 9B illustrates a PUCCH power control set information element according to some aspects of the present disclosure.

FIG. 10A illustrates a UL control channel configuration with a NACK-specific beam configuration according to some aspects of the present disclosure.

FIG. 10B illustrates a UL control channel transmission scheme for an acknowledgement (ACK) according to some aspects of the present disclosure.

FIG. 10C illustrates a UL control channel transmission scheme for a NACK transmission according to some aspects of the present disclosure.

FIG. 10D illustrates a UL control channel transmission scheme for a NACK transmission according to some aspects of the present disclosure.

FIG. 10E illustrates a UL control channel transmission scheme for a NACK according to some aspects of the present disclosure.

FIG. 11 illustrates a UL control channel resource configuration according to some aspects of the present disclosure.

FIG. 12 is a flow diagram illustrating a UL control channel transmission method according to some aspects of the present disclosure.

FIG. 13 illustrates a UL control channel transmission scheme according to some aspects of the present disclosure.

FIG. 14 illustrates a UL control channel transmission scheme according to some aspects of the present disclosure.

FIG. 15 illustrates a UL control channel transmission scheme according to some aspects of the present disclosure.

FIG. 16 is a flow diagram of a wireless communication method according to some aspects of the present disclosure.

FIG. 17 is a flow diagram of a wireless communication method according to some aspects of the present disclosure.

FIG. 18 illustrates example operations for wireless communication by a user equipment, in accordance with various aspects of the disclosure.

FIG. 19 illustrates example operations for wireless communication by a network entity, in accordance with various aspects of the disclosure.

FIG. 20 illustrates an example downlink control information (DCI) with a field for indicating changes to an acknowledgment feedback mode, in accordance with various aspects of the disclosure.

FIG. 21 illustrates an example call flow diagram for processing signaling indicating changes to an acknowledgment feedback mode, in accordance with various aspects of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., — 10 Tbps/km²), extreme data rates (e.g., multi-Gbps rate, 100+Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may include at least one element of a claim.

Hybrid automatic repeat request (HARQ) is a physical layer protocol, which combines the use of forward error correction (FEC) with automatic repeat request (ARQ)-control. For instance, a transmitter may transmit a data transmission with FEC encoding to a receiver. When FEC decoding is successful at the receiver, the receiver may feedback an acknowledgement (ACK) to the transmitter. When FEC decoding fails at the receiver, the receiver may feedback a negative-acknowledgement (NACK) to the transmitter. Upon receiving a NACK, the transmitter may perform a retransmission. For instance, the reception of a NACK at a transmitter may indicate that there is an error in a transmission, and thus may likely trigger a radio link adaptation procedure at the transmitter. For example, the transmitter may adjust a modulation coding scheme (MCS) to adapt to a link quality. If there is an error in a NACK transmission (e.g., when a NACK is received as an ACK by the transmitter), the errors in a corresponding data transmission may not be corrected until the errors are detected by higher layers (e.g., a radio link control (RLC) layer and/or a packet data convergence protocol (PDCP) layer). For example, when a RLC operates in acknowledged mode (AM), the errors can be corrected at the RLC layer, which may trigger a retransmission. When the RLC operates in unacknowledged mode (UM) or transparent mode (TM), the errors may not be corrected until the errors are detected at a PDCP layer, which may trigger a retransmission. As the errors are propagated to the higher layers and corrected at the higher layers, the transmission delay increases. As such, an error in a NACK transmission can result in a high delay.

Various mechanisms and techniques for transmitting ACKs and NACKs with different transmission reliability levels are provided. For instance, a BS may configure a UE with a physical control channel (PUCCH) configuration for transmitting ACK/NACKs. The PUCCH configuration may include a NACK-specific transmission configuration for transmitting NACK transmissions with a higher transmission reliability than ACK transmissions. The higher transmission reliability may correspond to less errors or a higher protection against errors. For instance, NACK transmissions may have a reliability of about 10⁻⁶, whereas ACK transmissions may have a reliability of about 10⁻⁵ for URLLC services for example. It is noted here that this difference in reliability between ACK and HARQ data transmission can coexist with the different in reliability between control channel and data channel. The NACK-specific transmission configuration may be applied to a NACK transmission, but not an ACK transmission. The BS may transmit a downlink (DL) data transmission to the UE (e.g., by using a given HARQ process). The UE may feedback a decoding status of the DL transmission by transmitting a PUCCH signal including an ACK or a NACK. If the decoding is successful, the UE may transmit the PUCCH signal including an ACK. If the decoding fails, the UE may transmit the PUCCH signal including a NACK based on the received NACK-specific transmission configuration.

In some aspects, the BS may configure the UE to utilize a higher transmission power for a NACK transmission than for an ACK transmission. In other words, transmit power boosting can be applied to a NACK transmission. For instance, the NACK-specific transmission configuration may include a flag indicating whether transmit power boosting may be applied to a NACK transmission. The NACK-specific transmission configuration may additionally indicate a transmit power increment or a transmit power boosting amount for a NACK transmission. In some instances, the BS may control NACK transmit power boosting separately for different PUCCH formats and/or different logical channels associated with different transmission physical layer formats (e.g., 4 dB power boosting for PUCCH format 0 and 1 dB power boosting for PUCCH format 1).

In some aspects, the BS may configure the UE to utilize more beams for a NACK transmission than for an ACK transmission. For instance, the NACK-specific transmission configuration may indicate a number of beams and/or a sequence of beam directions for NACK transmissions. Depending on the UE's capabilities, the UE may transmit a NACK transmission in multiple beam directions sequentially in a beam-switching manner or simultaneously. For instance, if the UE has a single-panel antenna, the UE may transmit a NACK transmission in multiple beam directions sequentially in time. Alternatively, if the UE has a multi-panel antenna, the UE may transmit a NACK transmission in multiple beam directions simultaneously.

In some aspects, the BS may configure the UE with different, separate resources for an ACK transmission and for a NACK transmission. The different resources may be different in a time domain, a frequency domain, and/or a spatial domain. In some aspects, the BS may restrict the content (e.g., uplink control information (UCI)) of a PUCCH signal that carries a NACK feedback. In some aspects, the BS may configure the UE with one or more of NACK transmit power boosting, NACK transmissions with multiple beams, separate ACK/NACK resources, and NACK-only transmissions.

Aspects of the present disclosure can provide several benefits. For example, transmitting a NACKs at a higher transmit power than an ACK and/or using a greater number of beams than an ACK can increase the transmission reliability of NACK transmissions. The improved NACK transmission reliability can increase the chances of erroneous data transmission to be corrected at a physical layer, rather than at higher layers such as RLC and PDCP layers, and thus transmission delays and/or block error rates (BLERs) can be reduced. Thus, the disclosed embodiments are suitable for use in ultra-reliable low-latency communication (URLLC). Transmit power boosting for NACK transmissions can impact performance when multiple UEs are multiplexed on the same resources. By utilizing different, separate resources for ACK transmissions and for NACK transmissions, impact from NACK transmit power boosting can be avoided. While the disclosed embodiments are described in the context of NR, the disclosed embodiments can be applied to any suitable wireless communication protocol to provide NACK transmissions with a higher transmission reliability than ACK transmissions.

Aspects of the present disclosure provide techniques for handling indications to change acknowledgment feedback modes. In some cases, rather than sending positive acknowledgments (ACKs), only NACKs may be sent to reduce signaling overhead. A missed NACK can lead to significant delays as higher layer error correction mechanisms may be required to recover NACK'd packets. Because NACKs are likely to occur in poor channel conditions that could also result in missed NACKs, NACKs may be sent with a mechanism for increased reliability.

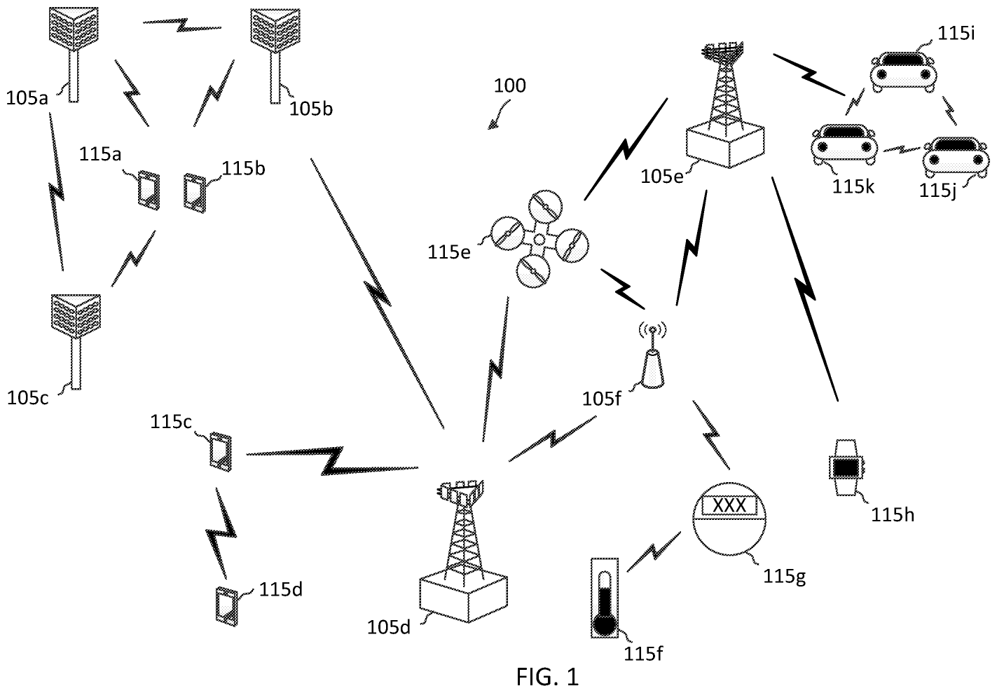

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such asV2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK (e.g., in a PUCCH) to the BS 105. Conversely, if the UE 115 fails to receive the DL transmission successfully, the UE 115 may transmit a HARQ NACK (e.g., in a PUCCH) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may provide a higher reliability or protection for a NACK transmission than for an ACK transmission. For instance, a BS 105 may configure a UE 115 to utilize a higher transmission power for a NACK transmission than for an ACK transmission. Alternatively or additionally, the BS 105 may configure the UE 115 to utilize more beams for a NACK transmission than for an ACK transmission. Alternatively or additionally, the BS 105 may configure the UE 115 with one resource for a NACK transmission and another resource for an ACK transmission. Alternatively or additionally, the BS 105 may restrict the content (e.g., uplink control information (UCI)) of a PUCCH signal that carries a NACK feedback. Mechanisms for HARQ ACK/NACK transmissions with different reliability levels are described in greater detail herein.

As initially explained above, aspects of the present disclosure provide techniques for communication devices to signal ACK/NACK feedback. In some scenarios, devices are configured to variously handle indications to change acknowledgment feedback modes. The ability to signal different acknowledgment feedback modes may provide flexibility to adapt feedback to different types of communication with different needs.

For example, ultra-reliable low-latency communications (URLLC) traffic, it may be desirable to send negative acknowledgment (NACK) feedback only, to avoid the signaling overhead of positive acknowledgment (ACK) feedback. In such cases, however, it is important that NACK feedback be received correctly, as a single erroneous reception (missed NACK) might trigger radio link adaptation and substantial delays. Further, in some cases, NACK to ACK errors (in which a NACK is mis-interpreted as an ACK) might not be corrected by radio link control (RLC) mechanisms.

Other mechanisms to reduce overhead are referred to as unacknowledged mode (UM) or transparent mode (TM) operation, where conventional physical layer ACK/NACK feedback is not utilized. In such cases, error correction performed by higher layers (e.g., higher than physical Packet Data Convergence Protocol (PDCP) layers might result in high delays. Further, maintaining the target BLER might be difficult (due to the lack of significant amount of feedback).

Thus, a NACK only acknowledgment feedback mode may be an alternative to UM or TM operation. In such cases, where NACK is the only feedback, there may be a need for higher reliability/protection of the NACK transmission (e.g., relative to an ACK transmission). Because a NACK indicates that an error has occurred with reception of a packet, it is also likely that radio link adaptation of some type may be need. This also means channel conditions are such that the likelihood of an error in NACK reception is increased. An error in the NACK transmission can typically be corrected only at the RLC layer, in case of RLC Acknowledged Mode (AM), or at even higher layers, in case of RLC UM or TM, resulting in additional delays.

By providing a mechanism to signal a change in acknowledgment feedback mode, aspects of the present disclosure may allow feedback modes to be adapted to different scenarios, such as those described above. For example, to save power, high reliability modes may be chosen only when there is a need to protect the NACK transmissions. When such a decision is made either at the network or at the UE side, the signaling mechanisms described herein may allow the network to notify a UE of the HARQ feedback mode and, in some cases, the UE may request a particular HARQ feedback mode.

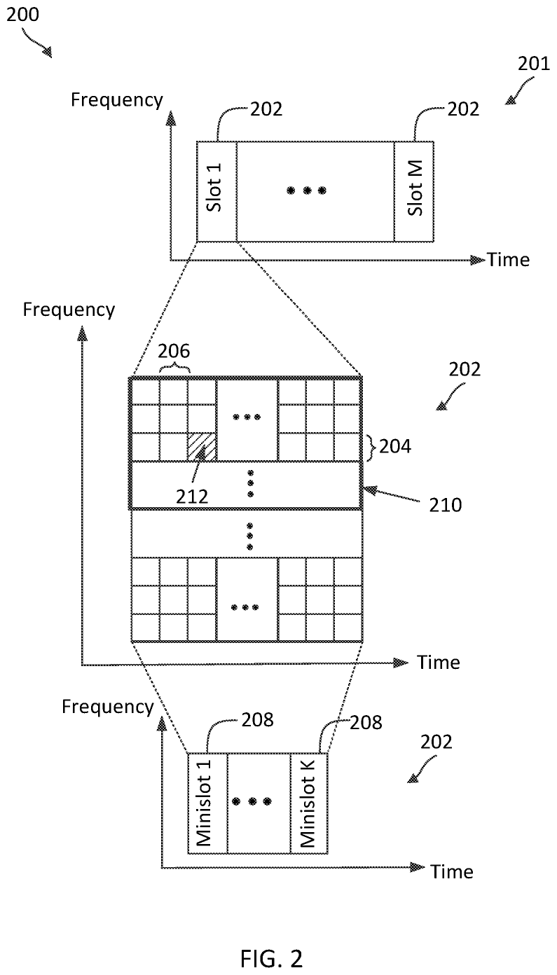

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In some aspects, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

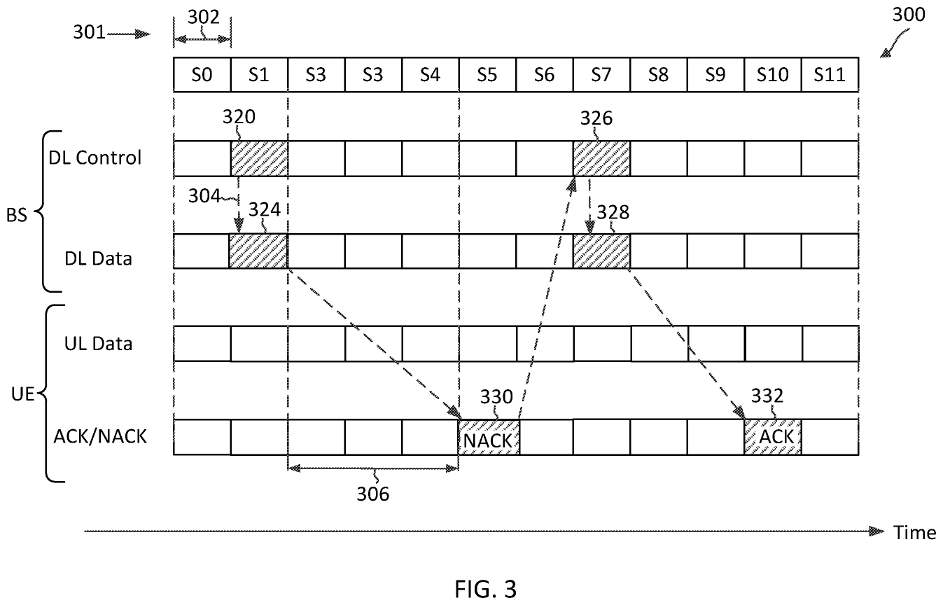

FIG. 3 illustrates a HARQ communication scenario 300 according to embodiments of the present disclosure. The x-axis represents time in some arbitrary units. The scenario 300 may correspond to a HARQ communication scenario between a BS 105 and a UE 115 of the network 100. The BS 105 and the UE 115 may communicate with each other using a substantially similar radio frame configuration as the radio frame structure 200. FIG. 3 shows a frame structure 301 including a plurality of slots 202 in time. The slots 202 are indexed from SO to S11. For example, a BS may communicate with a UE in units of slots 202. The slots 202 may also be referred to as transmission time intervals (TTIs). Each slot 202 or TTI carry a medium access control (MAC) layer transport block. Each slot 202 may include a number of symbols in time and a number of frequency tones in frequency. Each slot 202 may include a DL control portion followed by at least one of a subsequent DL data portion, UL data portion, and/or a UL control portion. In the context of LTE or NR, the DL control portion, the DL data portion, the UL data portion, and the UL control portion may be referred to as a PDCCH, a PDSCH, a PUSCH, and a PUCCH, respectively.

In FIG. 3, the pattern-filled boxes represent transmissions of DL control information, DL data, UL data, an ACK, and/or an NACK in corresponding slots 304. While an entire slot 202 is pattern-filled, a transmission may occur only in a corresponding portion of the slot 202. As shown, a BS (e.g., a BS 105) transmits DL control information 320 in the slot 202 indexed Si (e.g., in a DL control portion of the slot 202). The DL control information 320 may indicate a DL grant for a UE (e.g., a UE 115) in the same slot 202 indexed S1. Additionally, the DL control information 320 may indicate a resource (e.g., in the slot 202 indexed S5) for a HARQ ACK/NACK feedback. Thus, the BS transmits a DL data signal 324 (including DL data) to the UE in the slot 202 indexed Si (e.g., in a DL data portion of the slot 202). The UE may receive the DL control information 320 and receive the DL data signal 324 based on the DL grant.

After receiving the DL data signal 324, the UE 115 may report a reception status of the DL data signal 324 to the BS by transmitting an ACK/NACK signal 330 in the slot 202 indexed S5 (e.g., in a UL data portion or a UL control portion of the slot 304) based on the DL control information 320. In the illustrated example of FIG. 3, the UE 115 fails to decode the DL data signal 324, and thus transmits a NACK in the ACK/NACK signal 330 as shown.

In some instances, the ACK/NACK signal 330 may be transmitted in a PUCCH. Thus, the ACK/NACK signal 330 may also be referred to as a PUCCH signal. In NR, a PUCCH signal may be in a PUCCH format, such as a PUCCH format 0, a PUCCH format 1, a PUCCH format 2, a PUCCH format 3, or a PUCCH format 4 and may carry various types of UCI (e.g., a HARQ ACK/NACK, a scheduling request (SR), and/or channel-state-information (CSI)) in a UCI payload. The different PUCCH formats may include different data lengths and may occupy different number of OFDM symbols. For example, PUCCH format 0 data may have a length of two bits or less and may be mapped to about 1-2 OFDM symbols. PUCCH format 1 data may have a length of two bits or less and may be mapped to about 4-14 OFDM symbols. PUCCH format 2 data may have a length greater than two bits and may be mapped to about 1-2 OFDM symbols. PUCCH format 2 data may have a length greater than two bits and may be mapped to about 1-2 OFDM symbols. PUCCH format 3 data may have a length of two bits or less and may be mapped to about 4-14 OFDM symbols. PUCCH format 4 data may have a length greater than two bits and may be mapped to about 4-14 OFDM symbols.

Upon receiving the NACK, the BS may retransmit the DL data to the UE. For instance, the BS transmits DL control information 326 in the slot 302 indexed S7 (e.g., in a DL control portion of the slot 304). The DL control information 326 may indicate a DL grant for the UE in the same slot 202 indexed S7. The DL control information 326 may also indicate a resource (e.g., in the slot 202 indexed S10) for a HARQ ACK/NACK feedback. The BS retransmits the DL data in a DL data signal 328 to the UE in the slot 202 indexed S7 (e.g., in a DL data portion of the slot 202). Upon receiving the DL data signal 328, the UE may transmit an ACK or a NACK to the BS depending on the decoding status for the DL data signal 324. If the UE transmits an ACK (in an ACK/NACK signal 332) during the slot 202 indexed S10 to the BS as shown, the BS may transmit new DL data to the UE in a next DL transmission. However, if the UE transmits a NACK to the BS, the BS may repeat the retransmission process until the UE successfully decode the DL data or when the retransmission reaches a certain retransmission limit (e.g., a retransmission count or a retransmission timeout).

HARQ techniques are commonly used to provide ultra-reliable low-latency communications with a packet error rate of less than about 10⁻⁴ to about 10⁻⁵. In URLLC, a single erroneous data reception may trigger a radio link adaptation. In certain scenarios, when RLC operates in UM or TM, where no RLC ACK/NACK is used, errors in NACK transmissions or ACK transmissions cannot be corrected at the RLC level. The errors may propagate to higher layers (e.g., a packet data convergence protocol (PDCP)). While errors can be corrected at the higher layers, correcting errors at the higher layer rather than at a lower layer (e.g., at the physical layer) can result in higher packet delays. Additionally, when the HARQ ACK/NACK feedback is unreliable, it may be difficult to maintain a certain block error rate (BLER) for a particular communication or data traffic (e.g., URLLC). Further, an error in a NACK transmission may have a greater impact than an error in an ACK transmission. For instance, an error in an ACK transmission may cause an unnecessary retransmission, whereas an error in a NACK transmission may cause the higher layer to timeout and request retransmission of multiple packets.

Accordingly, the present disclosure provides techniques for a UE to transmitting an HARQ NACK with a higher reliability level than an HARQ ACK.

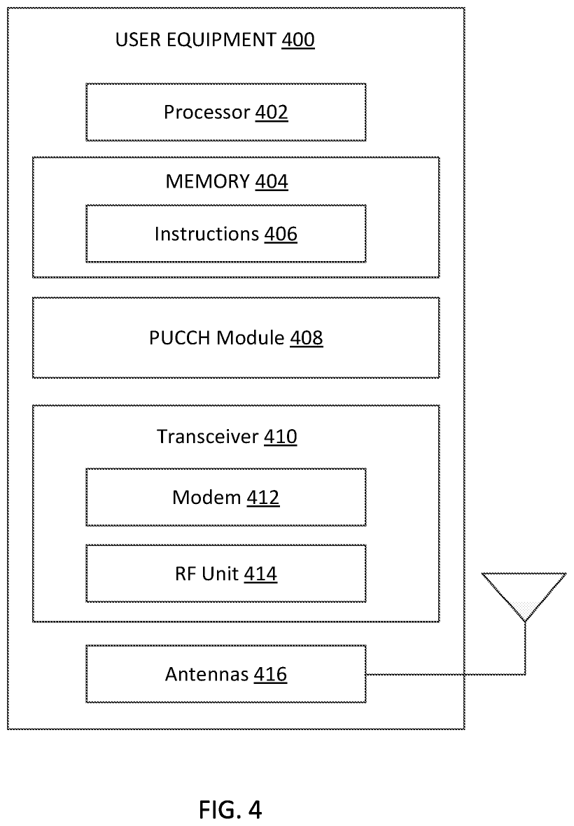

FIG. 4 is a block diagram of an exemplary UE 400 according to some aspects of the present disclosure. The UE 400 may be a UE 115 discussed above in FIG. 1. As shown, the UE 400 may include a processor 402, a memory 404, a PUCCH module 408, a transceiver 410 including a modem subsystem 412 and a radio frequency (RF) unit 414, and one or more antennas 416. These elements may be coupled with one another. The term “coupled” may refer to directly or indirectly coupled or connected to one or more intervening elements. For instance, these elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 404 includes a non-transitory computer-readable medium. The memory 404 may store, or have recorded thereon, instructions 406. The instructions 406 may include instructions that, when executed by the processor 402, cause the processor 402 to perform the operations described herein with reference to the UEs 115 in connection with aspects of the present disclosure, for example, aspects of FIGS. 1-3, 6A-6D, 7A-7C, 8A-8B, 9A-9B, 10A-10E, 11-16, 18, 20, and 21. Instructions 406 may also be referred to as program code. The program code may be for causing a wireless communication device to perform these operations, for example by causing one or more processors (such as processor 402) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The PUCCH module 408 may be implemented via hardware, software, or combinations thereof. For example, the PUCCH module 408 may be implemented as a processor, circuit, and/or instructions 406 stored in the memory 404 and executed by the processor 402. In some instances, the PUCCH module 408 can be integrated within the modem subsystem 412. For example, the PUCCH module 408 can be implemented by a combination of software components (e.g., executed by a DSP or a general processor) and hardware components (e.g., logic gates and circuitry) within the modem subsystem 412.

The PUCCH module 408 may be used for various aspects of the present disclosure, for example, aspects of FIGS. 1-3, 6A-6D, 7A-7C, 8A-8B, 9A-9B, 10A-10E, 11-16, 18, 20, and 21. For instance, the PUCCH module 408 is configured to receive a NACK transmission configuration from a BS (e.g., the BSs 105), receive a DL data transmission from the BS, and transmit, to the BS, a PUCCH signal including a NACK for the data transmission based on the received NACK transmission configuration.

In some aspects, the NACK transmission configuration may include a flag indicating whether to increase or boost a transmit power of the PUCCH signal when the PUCCH signal includes the NACK. In some aspects, the NACK transmission configuration may include a plurality of transmit power parameters (for boosting a transmit power), where each transmit power parameter may be associated with a logical channel (or a transmission physical layer format) and/or a PUCCH format (e.g., PUCCH format 0, PUCCH format 1, PUCCH format 2, PUCCH format 3, or PUCCH format 4). Thus, the PUCCH module 408 is further configured to transmit the PUCCH signal with transmit power boosting based on the NACK transmission configuration.

In some aspects, the NACK transmission configuration may include one or more beam parameters (e.g., a number of beams, a beam sequence, and/or a multi-beam transmission configuration). Thus, the PUCCH module 408 is further configured to transmit the PUCCH signal in multiple beam directions. In some aspects, the UE 400 may include a single panel including the one or more antenna 416, and thus the PUCCH module 408 is configured to transmit the PUCCH signal in the multiple beam directions sequentially (switching beam directions for the mutlipel transmission). In some aspects, the UE 400 may include a multiple panels including the one or more antenna 416, and thus the PUCCH module 408 is configured to transmit the PUCCH signal in the multiple beam directions simultaneously.

In some aspects, the NACK transmission configuration may indicate a NACK resource allocation different from an ACK resource allocation. Thus, the PUCCH module 408 is configured to transmit the PUCCH signal using a NACK-specific resource indicated by the NACK resource allocation. In some aspects, the PUCCH signal may be a NACK-only transmission without other UCI and/or may be in a certain PUCCH format based on rules indicated by the NACK transmission configuration. In some aspects, the PUCCH module 408 is configured to transmit the PUCCH signal including the NACK using one or more of transmit power boosting, multiple beams, NACK-specific resources, and NACK-only transmission rules to improve the reliability of NACK transmissions. Mechanisms for transmitting ACKs and NACKs with different reliability are described in greater detail herein.

As shown, the transceiver 410 may include the modem subsystem 412 and the RF unit 414. The transceiver 410 can be configured to communicate bi-directionally with other devices, such as the BSs 105. The modem subsystem 412 may be configured to modulate and/or encode the data from the memory 404 and/or the PUCCH module 408 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 414 may be configured to process (e.g., perform analog to digital conversion or digital to analog conversion, etc.) modulated/encoded data (e.g., HARQ ACK/NACKs, PUSCH data, PUCCH, URLLC traffic, non-URLLC UL traffic) from the modem subsystem 412 (on outbound transmissions) or of transmissions originating from another source such as a UE 115 or a BS 105. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 115 to enable the UE 115 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices. The antennas 416 may provide the received data messages for processing and/or demodulation at the transceiver 410. The transceiver 410 may provide the demodulated and decoded data (e.g., SSBs, PUCCH configuration, DL data transmission with HARQ, PDSCH, PDCCH) to the PUCCH module 408 for processing. The antennas 416 may include multiple antennas of similar or different designs in order to sustain multiple transmission links. The RF unit 414 may configure the antennas 416. In some aspects, the RF unit 414 may include various RF components, such switches and/or controls, that can control the antennas 416 to receive and/or transmit in certain beam directions.

In some aspects, the transceiver 410 is configured to receive a NACK transmission configuration from a BS (e.g., the BSs 105), receive a DL data transmission from the BS, and transmit, to the BS, a PUCCH signal including a NACK for the data transmission based on the received NACK transmission configuration, for example, by coordinating with the PUCCH module 408.

In an aspect, the UE 400 can include multiple transceivers 410 implementing different RATs (e.g., NR and LTE). In an aspect, the UE 400 can include a single transceiver 410 implementing multiple RATs (e.g., NR and LTE). In an aspect, the transceiver 410 can include various components, where different combinations of components can implement different RATs.

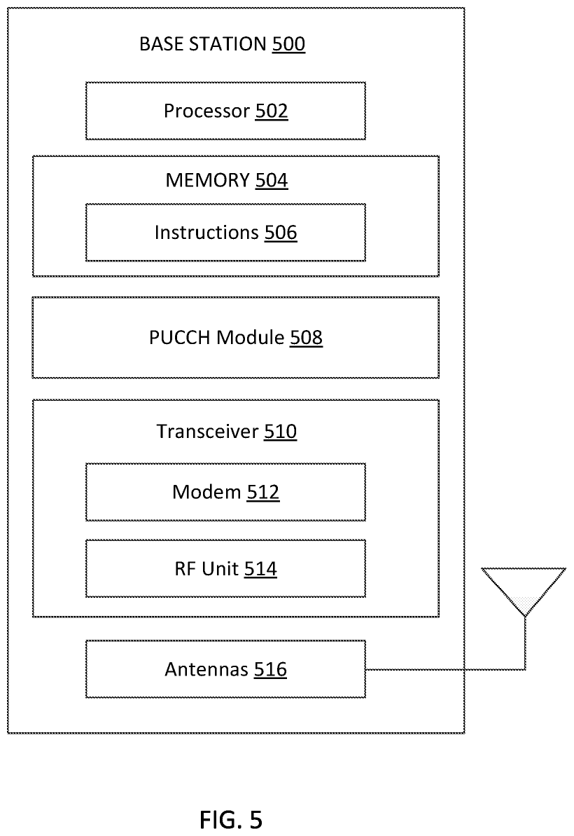

FIG. 5 is a block diagram of an exemplary BS 500 according to some aspects of the present disclosure. The BS 500 may be a BS 105 in the network 100 as discussed above in FIG. 1. As shown, the BS 500 may include a processor 502, a memory 504, a PUCCH module 508, a transceiver 510 including a modem subsystem 512 and a RF unit 514, and one or more antennas 516. These elements may be coupled with one another. The term “coupled” may refer to directly or indirectly coupled or connected to one or more intervening elements. For instance, these elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 1-3, 6A-6D, 7A-7C, 8A-8B, 9A-9B, 10A-10E, 11-15, 17, and 19-21. Instructions 506 may also be referred to as code, which may be interpreted broadly to include any type of computer-readable statement(s) as discussed above with respect to FIG. 4.

The PUCCH module 508 may be implemented via hardware, software, or combinations thereof. For example, the PUCCH module 508 may be implemented as a processor, circuit, and/or instructions 506 stored in the memory 504 and executed by the processor 502. In some instances, the PUCCH module 508 can be integrated within the modem subsystem 512. For example, the PUCCH module 508 can be implemented by a combination of software components (e.g., executed by a DSP or a general processor) and hardware components (e.g., logic gates and circuitry) within the modem subsystem 512.

The PUCCH module 508 may be used for various aspects of the present disclosure, for example, aspects of FIGS. 1-3, 6A-6D, 7A-7C, 8A-8B, 9A-9B, 10A-10E, 11-15, 17, and 19-21. For instance, the PUCCH module 508 is configured to transmit a NACK transmission configuration to a UE (e.g., the UEs 115a and/or 400), transmit a DL data transmission to the UE, and receive, from the UE, a PUCCH signal including a NACK for the data transmission based on the received NACK transmission configuration.

In some aspects, the NACK transmission configuration may include a flag indicating whether to increase or boost a transmit power of the PUCCH signal when the PUCCH signal includes the NACK. In some aspects, the NACK transmission configuration may include a plurality of transmit power parameters (for boosting a transmit power), where each transmit power parameter may be associated with a logical channel (or a transmission physical layer format) and/or a PUCCH format (e.g., PUCCH format 0, PUCCH format 1, PUCCH format 2, PUCCH format 3, or PUCCH format 4).

In some aspects, the NACK transmission configuration may include one or more beam parameters (e.g., a number of beams, a beam sequence, and/or a multi-beam transmission configuration). Thus, the PUCCH module 508 is further configured to receive the PUCCH signal in multiple beam directions sequentially or simultaneously.

In some aspects, the NACK transmission configuration may indicate a NACK resource allocation different from an ACK resource allocation. Thus, the PUCCH module 508 is configured to monitor for an ACK/NACK for the DL data transmission in NACK-specific resources indicated by the NACK resource allocation and non-NACK resources indicated by the ACK resource allocation, and receive the PUCCH signal from a NACK-specific resource indicated by the NACK resource allocationIn some aspects, the PUCCH signal may be a NACK-only transmission without other UCI and/or may be in a certain PUCCH format based on rules indicated by the NACK transmission configuration. In some aspects, the NACK transmission configuration may include parameters for one or more of transmit power boosting, multiple beams, NACK-specific resources, and NACK-only transmission rules to improve the reliability of NACK transmissions. Mechanisms for configuring ACK transmissions and NACK transmissions with different reliability are described in greater detail herein.

As shown, the transceiver 510 may include the modem subsystem 512 and the RF unit 514. The transceiver 510 can be configured to communicate bi-directionally with other devices, such as the UEs 115 and/or 400 and/or another core network element. The modem subsystem 512 may be configured to modulate and/or encode data according to a MCS, e.g., a LDPC coding scheme, a turbo coding scheme, a convolutional coding scheme, a polar coding scheme, a digital beamforming scheme, etc. The RF unit 514 may be configured to process (e.g., perform analog to digital conversion or digital to analog conversion, etc.) modulated/encoded data (e.g., SSBs, PUCCH configuration, DL data transmission with HARQ, PDSCH, PDCCH) from the modem subsystem 512 (on outbound transmissions) or of transmissions originating from another source such as a UE 115 and/or UE 400. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 105 to enable the BS 105 to communicate with other devices.

The RF unit 514 may provide the modulated and/or processed data, e.g. data packets (or, more generally, data messages that may contain one or more data packets and other information), to the antennas 516 for transmission to one or more other devices. This may include, for example, transmission of information to complete attachment to a network and communication with a camped UE 115 or 400 according to some aspects of the present disclosure. The antennas 516 may further receive data messages transmitted from other devices and provide the received data messages for processing and/or demodulation at the transceiver 510. The transceiver 510 may provide the demodulated and decoded data (e.g., HARQ ACK/NACKs, PUSCH data, PUCCH, URLLC traffic, non-URLLC UL traffic) to the PUCCH module 508 for processing. The antennas 516 may include multiple antennas of similar or different designs in order to sustain multiple transmission links.

In some aspects, the transceiver 510 is configured to transmit a NACK transmission configuration to a UE (e.g., the UEs 115 and/or 400), transmit a DL data transmission from the BS, and receive, from the UE, a PUCCH signal including a NACK for the data transmission based on the received NACK transmission configuration, for example, by coordinating with the PUCCH module 508.

In an aspect, the BS 500 can include multiple transceivers 510 implementing different RATs (e.g., NR and LTE). In an aspect, the BS 500 can include a single transceiver 510 implementing multiple RATs (e.g., NR and LTE). In an aspect, the transceiver 510 can include various components, where different combinations of components can implement different RATs.

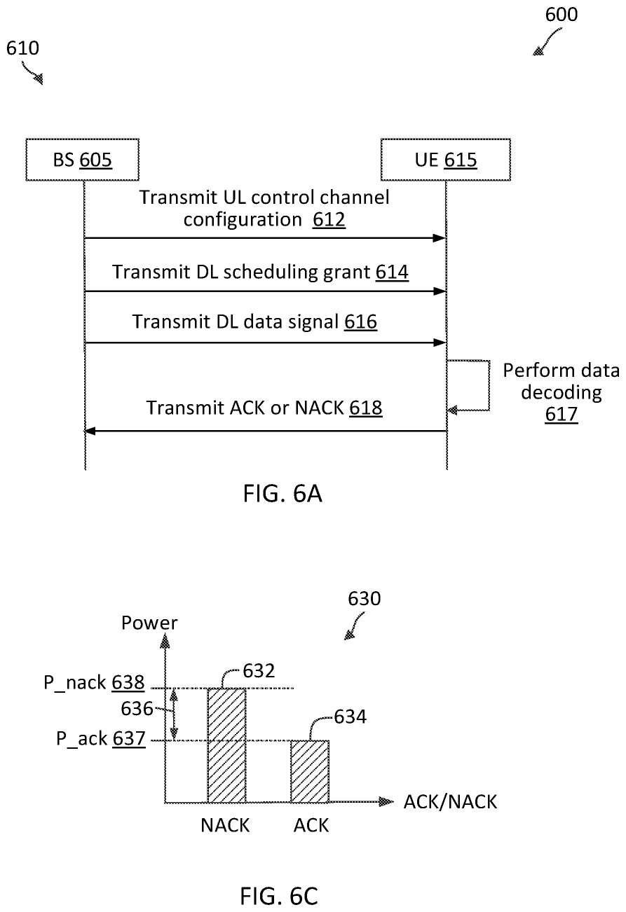

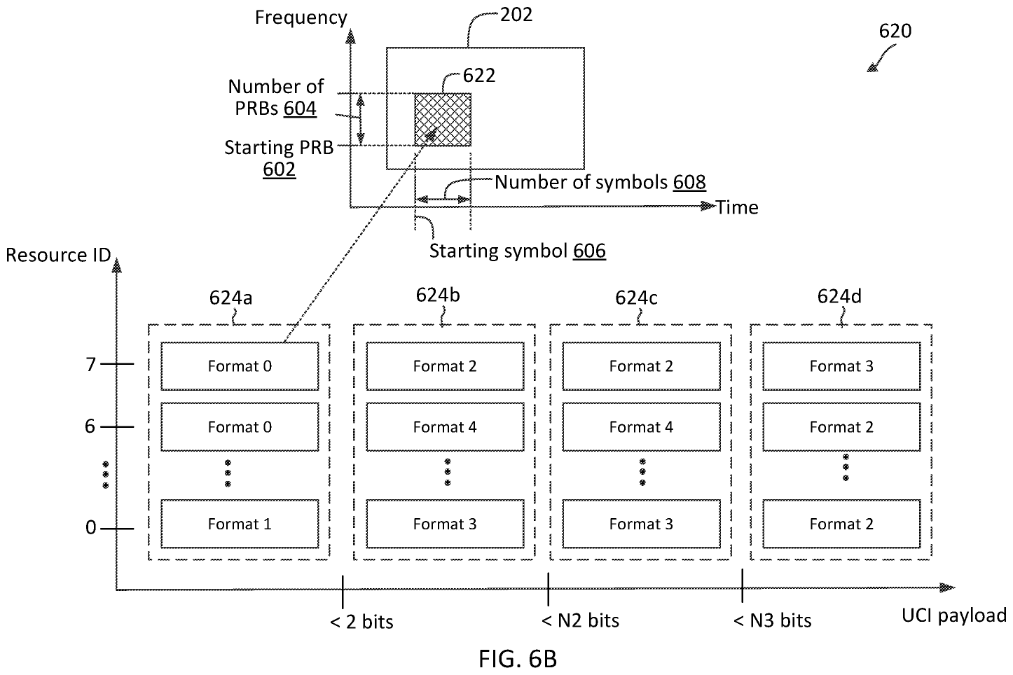

FIG. 6A is discussed in relation to FIGS. 6B and 6C to illustrate a HARQ transmission scheme 600 where a UE may transmit a HARQ NACK at a higher transmit power than a HARQ ACK to increase the reliability of a HARQ NACK transmission. FIG. 6A is a signaling diagram illustrating a HARQ transmission method 610 according to some aspects of the present disclosure. The method 610 may be implemented between a BS (e.g., BSs 105 and/or 500) and a UE (e.g., UEs 115 and/or 400). The method 610 may employ similar mechanisms as in the scenario 300 described above with respect to FIG. 3. As illustrated, the method 610 includes a number of enumerated steps, but embodiments of the method 610 may include additional steps before, after, and in between the enumerated steps. In some embodiments, one or more of the enumerated steps may be omitted or performed in a different order.

At step 612, a BS 605 (e.g., BSs 105 and/or 500) transmits a UL control channel configuration to a UE 615 (e.g., UEs 115 and/or 400). For instance, the BS 605 and the UE 615 has established a connection via an initial network acquisition procedure as described above in FIG. 1. The BS 605 may be serving the UE in an active BWP of a serving cell. The UL control channel configuration may be a UE-specific configuration for the UE 615 in the active BWP of the serving cell. The UL control channel configuration may include resource allocation information, spatial transmission information, transmit power control information, and/or any information related to transmission in a UL control channel (e.g., a PUCCH). In some instances, the UL control channel configuration may be an NR PUCCH configuration (e.g., a RRC configuration). In some aspects, the UL control channel configuration may indicate a resource for transmitting a UL control channel signal (e.g., a PUCCH signal) as shown in FIG. 6B discussed below. In some aspects, the UL control channel configuration may indicate transmit power control mechanisms as shown in FIG. 6C discussed below.

FIG. 6B illustrates a UL control channel resource configuration 620 according to some aspects of the present disclosure. The scheme 620 may be employed by BSs such as the BSs 105 and/or 500 and UEs such as the UEs 115 and/or 400 in a network such as the network 100. For instance, the BS 605 may indicate a UL control channel resource configured for the UE 615 as shown in FIG. 6B.

In the scheme 620, the BS 605 may configure the UE 615 with a resource 622 as shown in the top half of FIG. 6B, where the x-axis represents time in some arbitrary units, and the y-axis represents frequency in some arbitrary units. The BS 605 may indicate the resource 622 in the slot 202. The BS 605 may include an indication of a starting physical resource block (PRB) 602, a number of PRBs 604, a starting symbol 606, and a number of symbols 608 in the UL control channel configuration. The starting PRB 602 may be similar to the RB 210, and the starting symbol 606 may be similar to the symbols 206. The UE 615 may transmit a PUCCH signal carrying an ACK or an NACK in the resource 622.

In some aspects, the BS 605 may configure the UE 615 with multiple PUCCH resource sets 624 (shown as 624a. 624b, 624c, and 624d) as shown in the bottom half of FIG. 6B, where the x-axis represents UCI payload size in units of bits, and the y-axis represents resource identifier (ID). Each resource set 624 may be identified by a resource ID. For instance, the resource set 624a may be identified by a resource set ID 1, the resource set 624b may be identified by a resource set ID 2, the resource set 624c may be identified by a resource set ID 3, and the resource set 624d may be identified by a resource set ID 4.

Each resource set 624 may indicate a plurality of PUCCH resources (e.g., similar to the resource 622) identified by a resource ID. In the illustrated example of FIG. 6B, each resource set 624 indicates 8 resources with resource IDs ranging from 0 to 7. Each resource may be allocated for a PUCCH transmission of a particular PUCCH format. For instance, in the resource set 624a, the resource (e.g., the resource 622) identified by resource ID 7 is configured for PUCCH format 0 transmission, the resource identified by resource ID 6 is also configured for PUCCH format 0 transmission, whereas the resource identified by resource ID 0 is configured for PUCCH format 1 transmission.

The resources in each resource set 624 may be configured for a PUCCH with certain UCI payload size (e.g., including SR, HARQ ACK/NACK, and/or CSI). For instance, the resource set 624a may be used for PUCCH transmission when the UCI payload size is less than about 2 bits, the resource set 624b may be used for PUCCH transmission when the UCI payload size is less than N2 bits, the resource set 624c may be used for PUCCH transmission when the UCI payload size is less than N3 bits, and the resource set 624d may be used for PUCCH transmission when the UCI payload size is greater than N3 bits. The BS 605 may include a configuration of the resource sets 624a, 624b, 624c, and 624d in the UL control channel configuration.

While FIG. 6B illustrates four resource sets 624, each including eight resources, in general, the BS 605 may configure a greater number of less number resource sets 624 (e.g., about 2, 3, 5 or more), each including a greater number of less number of resources 622 (e.g., about 2, 3, 4, 5, 6, 7 or more).

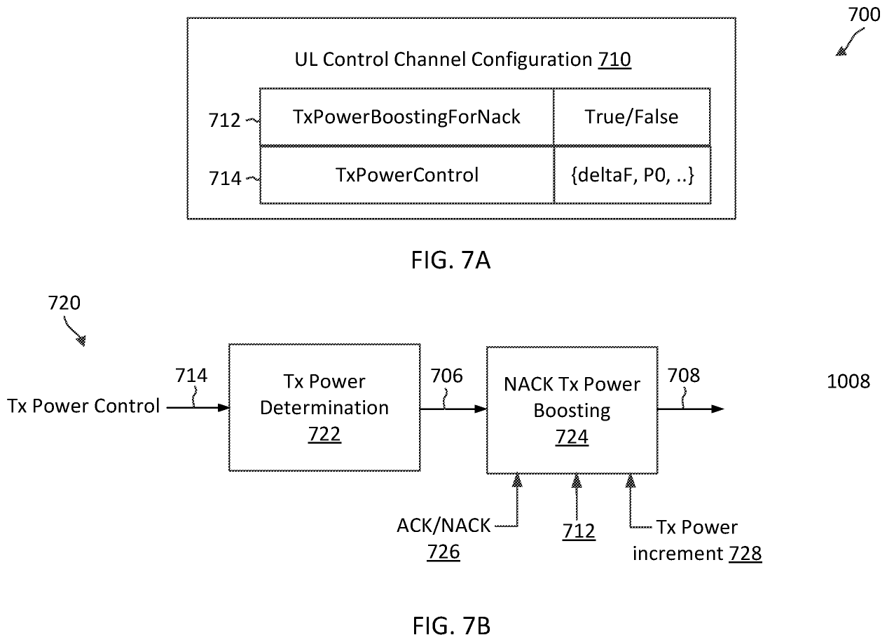

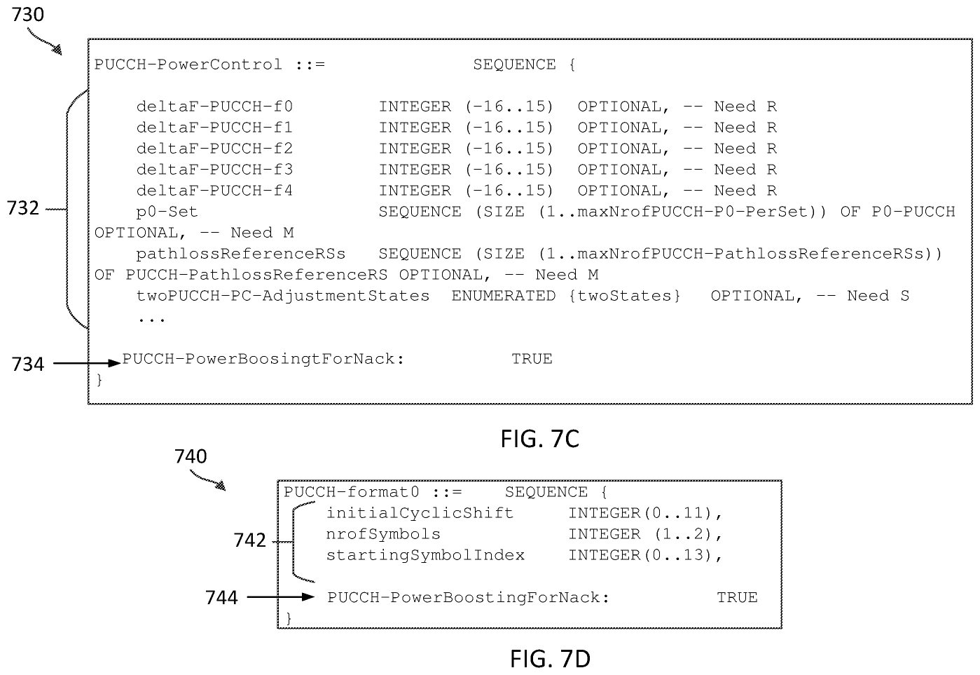

FIG. 6C illustrates a HARQ ACK/NACK transmission scheme 630 according to some aspects of the present disclosure. The scheme 630 may be employed by BSs such as the BSs 105 and/or 500 and UEs such as the UEs 115 and/or 400 in a network such as the network 100. For instance, the BS 605 may configure the UE 615 with a transmit power boosting for NACK transmission as shown in FIG. 6C. In FIG. 6C, the x-axis represents ACK/NACK transmission instances, and the y-axis represents power in some constant units. As shown, an ACK transmission 634 may be transmitted at a power level 637, denoted as P_ack, and a NACK transmission 632 may be transmitted at a power level 638, denoted as P_nack, which is higher than P_ack (e.g., by be X dB as shown by the reference numeral 636). The BS 605 may configure the higher P_nack power level 638 in the UL channel configuration in various forms as will be discussed in greater detail below in FIGS. 7-11.

Returning to FIG. 6A, at step 614, the BS 605 transmits a DL scheduling grant (e.g., the DL control information 320) for a DL data signal (e.g., the DL data signal 324) to the UE 615. The DL scheduling grant may be transmitted in the form of downlink control information (DCI) via PDCCH. The DCI may indicate a resource (e.g., time-frequency resources in terms of RBs 210 and/or symbols 206) for a DL data transmission. The DL scheduling grant may also indicate other transmission parameters (e.g., MCS) associated with the transmission of the DL data signal. Additionally, the DCI may include an indication of a PUCCH resource ID (e.g., the resource ID 0 to 7 shown in FIG. 6B) for transmitting a PUCCH transmission to report a HARQ ACK/NACK for the scheduled DL data transmission.

At step 616, the BS 605 transmits a DL data signal (e.g., via PDSCH) to the UE 615 according to the DL scheduling grant. The DL data transmission may be associated with a HARQ process. The UE 615 receives the DL data transmission according to the received DL scheduling grant.

At step 617, upon receiving the DL data transmission, the UE 615 performs data decoding, for example, according to the MCS indicated by the DL scheduling grant, on the received DL data signal to recover the original transmitted DL data.

At step 618, the UE 615 transmits an ACK or a NACK to the BS 605 to indicate a reception or decoding status of the DL data signal. For instance, if the UE 615 successfully decoded the DL data at step 617, the UE 615 may transmit an ACK to the BS 605. Conversely, if the UE 615 fails to decode the DL data at step 617, the UE 615 may transmit a NACK to the BS 605. The UE 615 may transmit the ACK or the NACK in the form of a PUCCH signal using a resource indicated by the UL control channel configuration and the DL scheduling grant. For instance, the DL scheduling grant may indicate a PUCCH resource ID of 7. The UE 615 may determine a payload size of the UCI to be carried in the PUCCH signal. For example, the UE 615 may determine that the UCI payload size for carrying the ACK or the NACK is less than 2 bits. Referring to the example shown in FIG. 6B, the UE 615 may select the resource set 624a based on the UCI payload size of less than 2 bits. The UE 615 may further select, from the resource set 624a, the resource 622 identified by the PUCCH resource ID of 7 for PUCCH format 0 (indicated by the DL scheduling grant). Thus, the UE 615 may transmit a PUCCH format 0 signal including the ACK or the NACK in the resource 622.

The UE 615 may further determine a transmit power for transmitting the PUCCH signal carrying the ACK or the NACK. Referring to FIG. 6C, if the DL data decoding was successful, the UE 615 may transmit the PUCCH formatO signal including the ACK in the resource 622 at the transmit power level 637 P_ack. If the DL data decoding fails, the UE 615 may transmit the PUCCH formatO signal including a NACK in the resource 622 at the higher transmit power level 638 P_nack.

In some aspects, the BS 605 may configure the same frequency, time, and spatial domain resource for ACK/NACK transmissions with a higher transmit power (e.g., the transmit power level 638 P_nack) for NACK transmissions. For instance, the BS 605 may configure the resource 622 and a certain spatial beam direction for ACK/NACK transmission. In some instances, the UE 615 may utilize the higher transmit power level 638 P_nack for a NACK transmission if there is a sufficient power headroom at the UE 615. If there is not a sufficient power headroom at the UE 615, the UE 615 may utilize a maximum transmit power allowable at the UE 615 to transmit a NACK transmission.

FIGS. 7A-7D, 8A-8B, and 9A-9B illustrate various mechanisms for configuring transmit power boosting for NACK transmissions. For instance, a transmit power for a NACK transmission can be X dB higher than the transmit power for an ACK transmission, where X can be any positive value.

FIG. 7A is discussed in relation to FIGS. 7B-7D to illustrate a UL control channel transmission scheme 700 with a NACK-specific transmit power configuration. FIG. 7A illustrates a UL control channel configuration 710 with a NACK-specific transmit power configuration according to some aspects of the present disclosure. FIG. 7B illustrates a UL control channel power control scheme 720 according to some aspects of the present disclosure. FIG. 7C illustrates a PUCCH power control information element 730 according to some aspects of the present disclosure. FIG. 7D illustrates a PUCCH format configuration information element 740 according to some aspects of the present disclosure. The scheme 700 may be employed by BSs such as the BSs 105, 500, and/or 605 and UEs such as the UEs 115, 400 and/or 615 in a network such as the network 100. The scheme 700 can be used in conjunction with the scheme 600 of FIG. 6. For instance, the BS 605 may configure the UE 615 with the UL control channel configuration 710 at step 612 of the method 610.

Referring to FIG. 7A, the configuration 710 may include a TxPowerBoostingForNack flag 712 and one or more TxPowerControl parameters 714. The TxPowerBoostingForNack flag 712 may be about 1-bit in length and may be a true/false flag, where a value of 1 may indicate true and a value of 0 may indicate false. If the TxPowerBoostingForNack flag 712 is true, transmit power boosting is applied for NACK transmissions. Conversely, if the TxPowerBoostingForNack flag 712 is false, transmit power boosting is not applied for NACK transmissions. The TxPowerControl parameters 714 may include various parameters, such as a deltaF parameter and a P0 parameter, for determining a PUCCH signal transmit power. The deltaF parameter is a transmit power offset parameter, which may be used to adjust a transmission performance. In some instances, the deltaF parameter may be an integer value between -16 to 15. In some instances, the TxPowerControl parameters 714 may include a deltaF parameter for each of the PUCCH format 0, PUCCH format 1, PUCCH format 2, PUCCH format 3, and PUCCH format 4. The P0 parameter is a target PUCCH signal received power at the BS 605.

Referring to FIG. 7B, the scheme 720 may include a transmit (Tx) power determination component 722 and a NACK transmit power boosting component 724. The transmit power determination component 722 and the NACK transmit power boosting component 724 can be implemented by hardware and/or software components. In some aspects, the transmit power determination component 722 and the NACK transmit power boosting component 724 are implemented by the PUCCH module 408 of FIG. 4.

The transmit power determination component 722 is configured to determine a transmit power for transmitting a PUCCH signal (e.g., the ACK/NACK signal 330) based on the TxPowerControl parameters 714. For instance, the transmit power determination component 722 may compute a transmit power 706 as shown below:

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix}\end{matrix} \} [ dBm ] , \qquad ( 1 )$$

as described in 3GPP document TS 38.213 Release 15, titled “3^{rd} Generation Partnership Project; Technical Specification Group Radio Access Network; NR; Physical layer procedures for control,” September, 2019, Section 7.2.1, which is incorporated herein by reference. The deltaF parameter and the P0 parameter in the TxPowerControl parameters 714 may correspond to the Δ_{F_PUCCH}(F) and P_{O_PUCCH,b,f,c} (qᵤ) in equation (1).

The NACK transmit power boosting component 724 is configured to determine whether to increase the transmit power 706 based on an input ACK/NACK 726, the TxPowerBoostingForNack flag 712, and a transmit (Tx) power increment 728. The input ACK/NACK 726 may be an ACK or a NACK to be included in the PUCCH signal. The transmit power increment 728 may be a predetermined transmit power increment (e.g., about 1 decibels (dB), 2 dB, 3 dB, 4 dB, 5 dB, 6 dB or more) to be used for increasing or boosting the transmission power level of the PUCCH signal when the ACK/NACK 726 is a NACK and the TxPowerBoostingForNack flag 712 is true. In other words, the NACK transmit power boosting component 724 may determine a transmit power 708 for a NACK transmission by adding the transmit power increment 728 to the transmit power 706. If the ACK/NACK 726 is a NACK and the TxPowerBoostingForNack flag 712 is false or the ACK/NACK 726 is an ACK, the NACK transmit power boosting component 724 may not add the transmit power increment 728 to the transmit power 706, and thus the output a transmit power 708 is the same as the transmit power 706.

In some aspects, the UL control channel configuration 710 may be similar to the PUCCH-Config information element described in 3GPP document TS 38.331 Release 15, titled “3^{rd} Generation Partnership Project; Technical Specification Group Radio Access Network; NR; Radio Resource Control (RRC) protocol specification,” September, 2019, Section 6.3.2, which is incorporated herein by reference. In some aspects, to enable a higher transmission power or transmit power boosting for NACK transmissions, the PUCCH-Config information element may include a pucch-PowerControl information element 730 as shown in FIG. 7C.

Referring to FIG. 7C, the pucch-PowerControl information element 730 includes a portion 732 and a portion 734. The parameters in the portion 732 may be substantially similar to the parameters in the pucch-PowerControl information element described in the 3GPP document TS 38.331 Release 15. The deltaF-PUCCH-f0 parameter, deltaF-PUCCH-f1 parameter, deltaF-PUCCH-f2 parameter, deltaF-PUCCH-f3 parameter, and deltaF-PUCCH-f4 parameter in the portion 732 is a deltaF parameter for PUCCH format 0, a deltaF parameter for PUCCH format 1, a deltaF parameter for PUCCH format 2, a deltaF parameter for PUCCH format 3, and a deltaF parameter for PUCCH format 4, respectively. For instance, when a NACK transmission is in a PUCCH format 0, the deltaF-PUCCH-f0 parameter can be substituted into Δ_{F_PUCCH}(F) of Equation (1) discussed above. The p0-Set parameter may include the target received power P0 parameter discussed above with reference to FIG. 7A. In some instances, the TxPowerControl parameters 714 may include similar parameters as in the portion 732. The portion 734 includes a PUCCH-PowerBoostingFlag parameter, which may correspond to the TxPowerBoostingForNack flag 712 in the configuration 710.

In some other instances, to enable a higher transmission power or transmit power boosting for NACK transmissions, the PUCCH- Config information element may include a PUCCH format information element 740 as shown in FIG. 7D.

Referring to FIG. 7D, the PUCCH format information element 740 includes a portion 742 and a portion 744. The parameters in the portion 742 may be substantially similar to the PUCCH format information element described in the 3GPP document TS 38.331 Release 15. The portion 744 includes a PUCCH-PowerBoostingFlag parameter, which may correspond to the TxPowerBoostingForNack flag 712 in the configuration 710. While FIG. 7D illustrates a PUCCH format for PUCCH format 0, a PUCCH-Config information element may include similar an information element similar to the PUCCH format information element 740 for each PUCCH format.

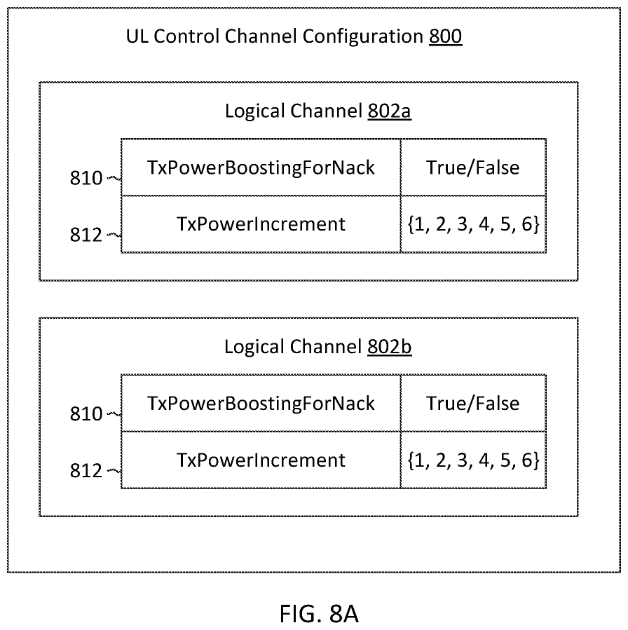

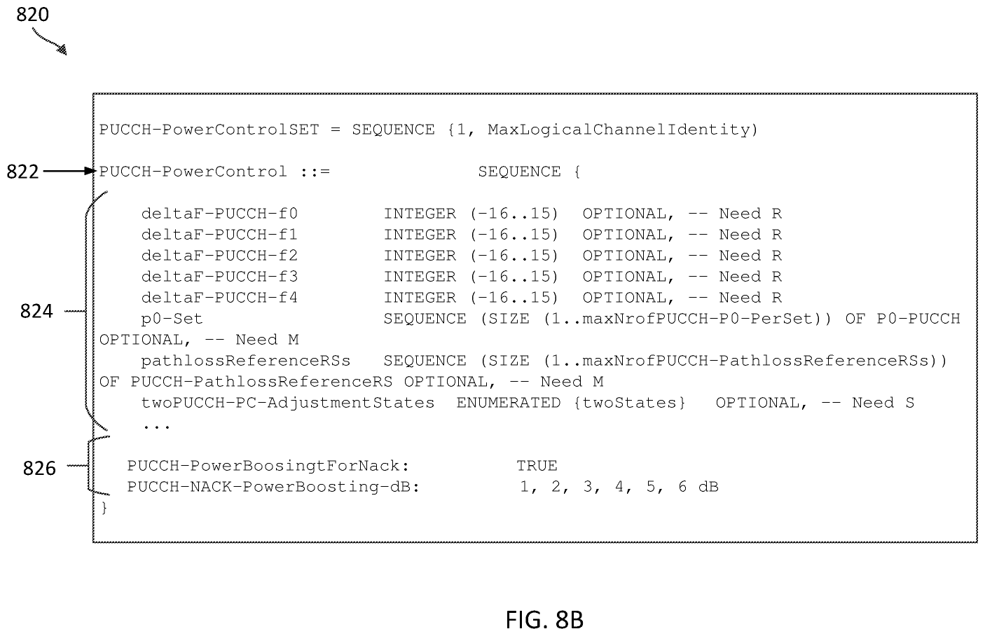

FIG. 8A is discussed in relation to FIG. 8B to illustrate mechanisms configuring a NACK-specific transmit power parameters to enable a higher transmission power for NACK transmissions compared to ACK transmission. FIG. 8A illustrates a UL control channel configuration 800 with a NACK-specific transmit power configuration according to some aspects of the present disclosure. The configuration 800 may be employed by BSs such as the BSs 105, 500, and/or 605 and UEs such as the UEs 115, 400 and/or 615 in a network such as the network 100. The configuration 800 can be used in conjunction with the scheme 600 of FIG. 6. For instance, the BS 605 may configure the UE 615 with a UL control channel configuration including the configuration 800 at step 612 of the method 610.

The configuration 800 includes a TxPowerBoostingForNack flag 810 and a TxPowerIncrement parameter 812 for each logical channel 802. For simplicity of illustration and discussion, FIG. 8 illustrates two logical channels 802a and 802b. However, the UL control channel configuration 800 may include any suitable number of logical channels 802. The logical channels 802 are associated with different transmission physical layer formats. The logical channels 802 may provide services (e.g., of different priorities and/or traffic types) for a medium access control (MAC) layer. For instance, the logical channel 802a may be configured to serve URLLC traffic, whereas the logical channel 802b may be configured to serve non-URLLC traffic. The TxPowerincrement parameter 812 may be similar to the transmit power increment 728, and the TxPowerBoostingForNack flag 810 may be similar to the TxPowerBoostingForNack flag 712. For instance, the TxPowerBoostingForNack flag 810 may be set to true or false to indicate whether transmit power boosting is applied to a corresponding NACK transmission and the TxPowerincrement parameter 812 may indicate a transmit power increment (e.g., in step of 1 dB as shown).

In some aspects, the configuration 800 can be used in conjunction with the scheme 720 discussed above with reference to FIG. 7B. For instance, the transmit power determination component 722 may be configured to determine the transmit power 706 for a PUCCH signal as shown in FIG. 7B. However, the NACK transmit power boosting component 724 is configured to determine whether to boost a transmit power for a NACK transmission and/or an amount for transmit power increment based on a logical channel associated with the NACK transmission. For instance, when the NACK transmission is a feedback for a DL data transmission (e.g., the DL data signals 324 and 326) associated with the logical channel 802a, the NACK transmit power boosting component 724 may determine whether to boost the transmit power for the NACK transmission based on the TxPowerBoostingForNack flag 810 configured for the logical channel 802a. If the TxPowerBoostingForNack flag 810 for the logical channel 802a is true, the NACK transmit power boosting component 724 may add the corresponding TxPowerincrement parameter 812 to the transmit power 706. If the TxPowerBoostingForNack flag 810 for the logical channel 802a is false, the NACK transmit power boosting component 724 may not add the corresponding TxPowerincrement parameter 812 to the transmit power 706.

FIG. 8B illustrates a PUCCH power control set information element 820 according to some aspects of the present disclosure. For instance, the PUCCH-Config information element described in the 3GPP document TS 38.331 Release 15 can be modified to include the PUCCH power control set information element 820 to provide similar NACK transmission power boosting as discussed in FIG. 8A. The PUCCH power control set information element 820 includes a pucch-PowerControl information element 822 for each logical channel (e.g., the logical channels 802), where each logical channel may be identified by a logical channel identity (e.g., 1, 2, 3, . . . ). Each pucch-PowerControl information element 822 includes a portion 824 and a portion 826. The portion 824 is substantially similar to the pucch-PowerControl information element described in the 3GPP document TS 38.331 Release 15 and the portion 732 shown in FIG. 7C. The portion 826 includes a PUCCH-PowerBoostingFlag parameter and a PUCCH-NACK-PowerBoosting-dB, which may correspond to the TxPowerBoostingForNack flag 810 and the TxPowerincrement parameter 812 in the configuration 800.

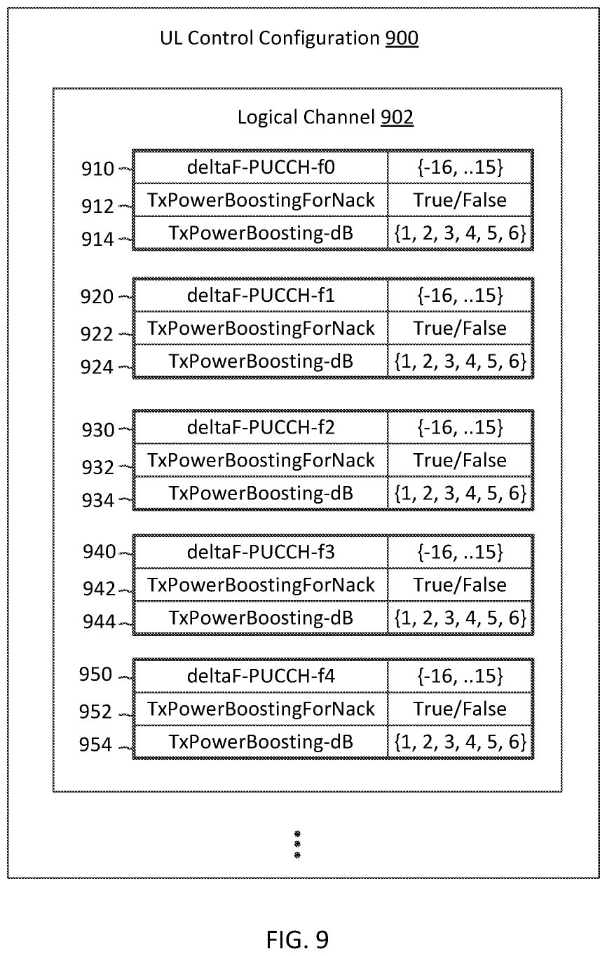

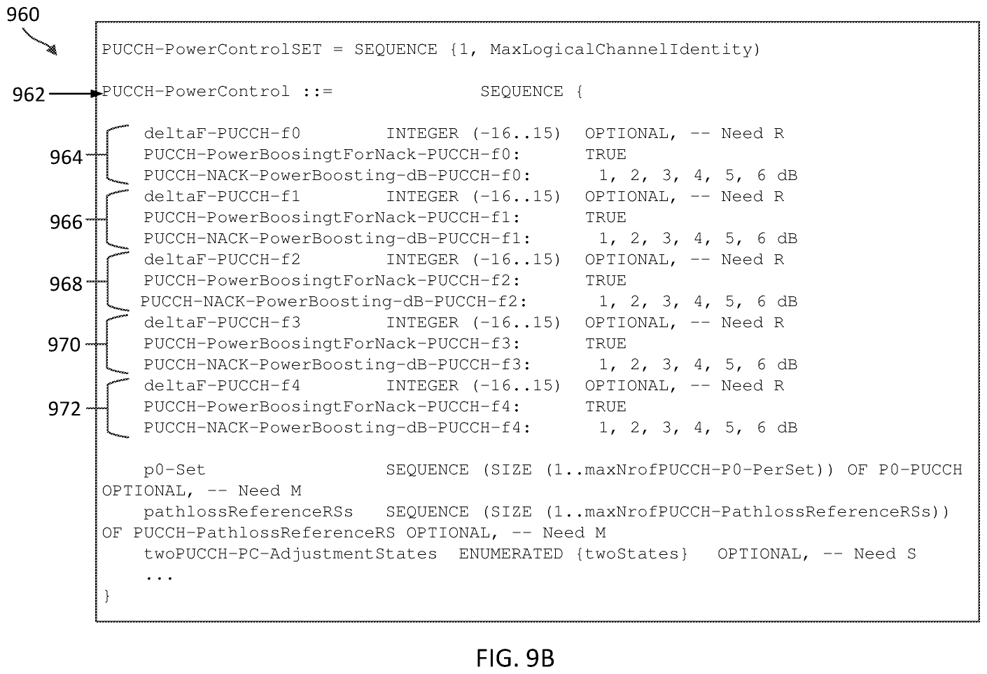

FIG. 9A is discussed in relation to FIG. 9B to illustrate mechanisms for configuring a NACK-specific transmit power parameters to enable a higher transmission power for NACK transmissions compared to ACK transmission. FIG. 9A illustrates a UL control channel configuration 900 with a NACK-specific transmit power configuration according to some aspects of the present disclosure. The configuration 800 700 may be employed by BSs such as the BSs 105, 500, and/or 605 and UEs such as the UEs 115, 400 and/or 615 in a network such as the network 100. For instance, the BS 605 may configure the UE 615 with a UL control channel configuration including the configuration 900 at step 612 of the method 610.

The configuration 900 includes a deltaF parameter, a TxPowerBoostingForNack flag and a TxPowerincrement parameter for each PUCCH format in each logical channel 902 (e.g., the logical channel 802). For simplicity of illustration and discussion, FIG. 9 illustrates one logical channel 902. However, the UL control channel configuration 900 may include any suitable number of logical channel 902. As shown, the configuration 900 includes a deltaF-PUCCH-f0 parameter 910, a TxPowerBoostingForNack flag 912, and a TxPowerincrement parameter 914 for PUCCH format 0. The configuration 900 further includes a deltaF-PUCCH-f1 parameter 920, a TxPowerBoostingForNack flag 922, and a TxPowerincrement parameter 924 for PUCCH format 1. The configuration 900 further includes a deltaF-PUCCH-f2 parameter 930, a TxPowerBoostingForNack flag 932, and a TxPowerincrement parameter 934 for PUCCH format 2. The configuration 900 further includes a deltaF-PUCCH-f3 parameter 940, a TxPowerBoostingForNack flag 942, and a TxPowerincrement parameter 944 for PUCCH format 3. The configuration 900 further includes a deltaF-PUCCH-f4 parameter 950, a TxPowerBoostingForNack flag 952, and a TxPowerincrement parameter 954 for PUCCH format 4. The deltaF-PUCCH-f0 parameter 910, deltaF-PUCCH-f1 parameter 920, deltaF-PUCCH-f2 parameter 930, deltaF-PUCCH-f3 parameter 940, and deltaF-PUCCH-f4 parameter 950 may be similar to the deltaF parameter and Δ_{F_PUCCH}(F) in equation (1) discussed above with respect to FIG. 7A. Each of the TxPowerBoostingForNack flags 912, 922, 932, 942, and 952 may be set to true or false to indicate whether transmit power boosting is applied to a NACK transmission in a corresponding PUCCH format. Each of the TxPowerincrement parameters 914, 924, 934, 944, and 954 may indicate a transmit power increment (e.g., in step of 1 dB as shown) for a NACK transmission in a corresponding PUCCH format.

In some aspects, the configuration 900 can be used in conjunction with the scheme 720 discussed above with reference to FIG. 7B. For instance, the transmit power determination component 722 may be configured to determine the transmit power 706 for a PUCCH signal as shown in FIG. 7B. However, the NACK transmit power boosting component 724 is configured to determine whether to boost a transmit power for a NACK transmission and an amount for transmit power increment based on a logical channel associated with the NACK transmission and a PUCCH format to be used for the NACK transmission.

For instance, when the NACK transmission is a feedback for a DL data transmission (e.g., the DL data signals 324 and 326) associated with the logical channel 902 and the NACK transmission is to be transmitted in a PUCCH format 1. The NACK transmit power boosting component 724 may determine whether to boost the transmit power for the NACK transmission based on the TxPowerBoostingForNack flag 922 configured for PUCCH format 1 in the logical channel 902. If the TxPowerBoostingForNack flag 922 is true, the NACK transmit power boosting component 724 may add the TxPowerincrement parameter 924 to the transmit power 706. If the TxPowerBoostingForNack flag 922 is false, the NACK transmit power boosting component 724 may not add the TxPowerincrement parameter 924 to the transmit power 706.

Alternatively, when the NACK transmission is a feedback for a DL data transmission (e.g., the DL data signals 324 and 326) associated with the logical channel 902 and the NACK transmission is to be transmitted in a PUCCH format 2. The NACK transmit power boosting component 724 may determine whether to boost the transmit power for the NACK transmission based on the TxPowerBoostingForNack flag 932 configured for PUCCH format 2 in the logical channel 902. If the TxPowerBoostingForNack flag 932 is true, the NACK transmit power boosting component 724 may add the TxPowerincrement parameter 934 to the transmit power 706. If the TxPowerBoostingForNack flag 932 is false, the NACK transmit power boosting component 724 may not add the TxPowerincrement parameter 934 to the transmit power 706.

FIG. 9B illustrates a PUCCH power control set information element 960 according to some aspects of the present disclosure. For instance, the PUCCH-Config information element described in the 3GPP document TS 38.331 Release 15 can be modified to include the PUCCH power control set information element 960 to provide similar NACK transmission power boosting as discussed in FIG. 9A. The PUCCH power control set information element 960 includes a pucch-PowerControl information element 962 for each logical channel (e.g., the logical channels 802), where each logical channel may be identified by a logical channel identity (e.g., 1, 2, 3, . . . ). Each pucch-PowerControl information element 962 includes a portion 964 for PUCCH format 0, a portion 966 for PUCCH format 1, a portion 968 for PUCCH format 2, a portion 970 for PUCCH format 3, and a portion 972 for PUCCH format 4.

In the portion 964, the deltaF-PUCCH-f0, the PUCCH-powerBoostingForNack-PUCCH-f0, PUCCH-NACK-PowerBoosting-dB-PUCCH-f0 may correspond to the deltaF-PUCCH-f0 parameter 910, the TxPowerBoostingForNack flag 912, and the TxPowerincrement parameter 914 in the configuration 900, respectively. In the portion 966, The deltaF-PUCCH-f1, the PUCCH-powerBoostingForNack-PUCCH-f1, PUCCH-NACK-PowerBoosting-dB-PUCCH-f1 may correspond to the deltaF-PUCCH-f1 parameter 920, the TxPowerBoostingForNack flag 922, and the TxPowerincrement parameter 924 in the configuration 900, respectively. In the portion 968, the deltaF-PUCCH-f2, the PUCCH-powerBoostingForNack-PUCCH-f2, PUCCH-NACK-PowerBoosting-dB-PUCCH-f2 may correspond to the deltaF-PUCCH-f2 parameter 930, the TxPowerBoostingForNack flag 932, and the TxPowerincrement parameter 934 in the configuration 900, respectively. In the portion 970, the deltaF-PUCCH-f3, the PUCCH-powerBoostingForNack-PUCCH-f3, PUCCH-NACK-PowerBoosting-dB-PUCCH-f3 may correspond to the deltaF-PUCCH-f3 parameter 940, the TxPowerBoostingForNack flag 942, and the TxPowerincrement parameter 944 in the configuration 900, respectively. In the portion 972, the deltaF-PUCCH-f4, the PUCCH-powerBoostingForNack-PUCCH-f4, PUCCH-NACK-PowerBoosting-dB-PUCCH-f4 may correspond to the deltaF-PUCCH-f4 parameter 950, a TxPowerBoostingForNack flag 952, and a TxPowerincrement parameter 954 in the configuration 900, respectively.

In some aspects, instead of computing a transmit power 706 as shown in Equation (1) and adding a transmit power increment (e.g., the transmit power increment 728) to the transmit power 706 to boost the transmit power for a NACK transmission as shown in the scheme 720 discussed above with reference to FIG. 7B, the transmit power offset deltaF parameter (e.g., Δ_{F_PUCCH}(F)) and/or the PUCCH target received power P0 parameter (e.g., P_{O_PUCCH,b,f,c} (qᵤ)) can be adjusted before computing the transmit power 706. For instance, a BS (e.g., the BSs 105, 500, and/or 605) may configure a UE (e.g., the UEs 115, 400, and/or 615) with a first transmit power offset deltaF parameter for an ACK transmission and a second transmit power offset deltaF parameter for a NACK transmission, where the second transmit power offset deltaF parameter may be different than the first transmit power offset deltaF parameter. The second transmit power offset deltaF parameter may be set to a value that can provide a higher transmit power than the first transmit power offset deltaF parameter. For instance, the second transmit power offset deltaF parameter may have a greater value than the first transmit power offset deltaF parameter. Thus, for an ACK transmission, the UE may select the first transmit power offset deltaF parameter for Δ_{F_PUCCH}(F) in Equation (1). For a NACK transmission, the UE may select the second transmit power offset deltaF parameter for Δ_{F_PUCCH}(F) in Equation (1). In some aspects, the BS may configure the UE with a first transmit power offset deltaF parameter and a second transmit power offset deltaF parameter for each logical channel (e.g., the logical channels 802 and 902), where the second transmit power offset deltaF parameter may have a greater value than the first transmit power offset deltaF parameter. In some aspects, the BS may configure the UE with a first transmit power offset deltaF parameter and a second transmit power offset deltaF parameter for each PUCCH format (e.g., the PUCCH format 0, PUCCH format 1, PUCCH format 2, PUCCH format 3, and PUCCH format 4) in each logical channel (e.g., the logical channels 802 and 902), where the second transmit power offset deltaF parameter may have a greater value than the first transmit power offset deltaF parameter.

Similarly, the BS may configure the UE with a first PUCCH target received power P0 parameter for an ACK transmission and a second PUCCH target received power P0 parameter for a NACK transmission, where the second PUCCH target received power P0 parameter may have a greater value than the first PUCCH target received power P0 parameter. Thus, for an ACK transmission, the UE may select the first PUCCH target received power P0 parameter for P_{O_PUCCH,b,f,c} (qᵤ) in Equation (1). For a NACK transmission, the UE may select the second PUCCH target received power P0 parameter for P_{O_PUCCH,b,f,c} (qᵤ) in Equation (1). In some aspects, the BS may configure the UE with a first PUCCH target received power P0 parameter and the second PUCCH target received power P0 parameter for each logical channel (e.g., the logical channels 802 and 902), where the second PUCCH target received power P0 parameter may have a greater value than the first PUCCH target received power P0 parameter. In some aspects, the BS may configure the UE with a first PUCCH target received power P0 parameter and the second PUCCH target received power P0 for each PUCCH format (e.g., the PUCCH format 0, PUCCH format 1, PUCCH format 2, PUCCH format 3, and PUCCH format 4) in each logical channel (e.g., the logical channels 802 and 902), where the second PUCCH target received power P0 parameter may have a greater value than the first PUCCH target received power P0 parameter.

In some aspects, new PUCCH formats can be defined for NACK transmissions. For instance, a PUCCH format 0_0, a PUCCH format 1_0, a PUCCH format 2_0, a PUCCH format 3_0, and a PUCCH format 4_0 can be defined for NACK transmissions. The PUCCH format 0_0 may be similar to PUCCH format 0, but with transmit power boosting. Similarly, the PUCCH format 1_0, the PUCCH format 2_0, the PUCCH format 3_0, and the PUCCH format 4_0 may be similar to PUCCH format 1, PUCCH format 2, PUCCH format 3, and PUCCH format 4, respectively, but with transmit power boosting. In other words, the PUCCH format 0_0, the PUCCH format 1_0, the PUCCH format 2_0, the PUCCH format 3_0, and the PUCCH format 4_0 are NACK-specific PUCCH format 0, NACK-specific PUCCH format 1, NACK-specific PUCCH format 2, NACK-specific PUCCH format 3, and NACK-specific PUCCH format 4, respectively.

Transmit power boosting at UEs can impact orthogonality and code-division-multiplexing (CDM). For instance, a BS (e.g., the BSs 105, 500, and/or 605) may assign multiple UEs (e.g., the UEs 115, 400, and/or 615) with the same time, frequency, and spatial domain resource for ACK/NACK transmissions, but with orthogonal codes for CDM. If one UE transmits an ACK using the resource at a first transmit power, and another UE transmits a NACK using the resource at a second transmit power with power boosting due to the NACK, the CDM performance can be impacted due to the different transmission powers between the NACK and the ACK transmissions. Thus, in some instances, transmit power boosting may not be applied for NACK transmission when CDM is used (e.g., for PUCCH format 2, 3, and/or 4). Alternatively, the BS may not configure UEs with CDM and NACK transmit power boosting to use the same time, frequency, and spatial domain resource for ACK and NACK transmissions.

In some other aspects, the BS may allocate a first resource for ACK transmissions and a second resource for NACK transmissions, where the first and second resources may be different in time (e.g., in different slots 202), frequency (e.g., different PRBs), and/or spatial domain (e.g., different beams). The BS may multiplex multiple UEs' ACK transmissions on the first resource via CDM. The BS may multiplex multiple UE's NACK transmission in the second resource with CDM when the UEs are configured with the same PUCCH format (e.g., the PUCCH format 0_0, the PUCCH format 1_0, the PUCCH format 2_0, the PUCCH format 3_0, or the PUCCH format 4_0) that applies NACK transmit power boosting. In other words, the BS may multiplex PUCCH transmissions of multiple UEs with similar transmit power on the same resource (in time, frequency, and spatial domain).

In some aspects, when a BS (e.g., the BSs 105, 500, and/or 605) configures a UE (e.g., the UEs 115, 400, and/or 615) with transmit power boosting for NACK transmissions, the BS may take into account the NACK transmit power boosting when performing UL transmit power control (TPC). For instance, when the BS receives a PUCCH signal with a NACK from the UE, the BS may be aware that the PUCCH signal is transmitted with transmit power boosting due to the NACK, and thus the BS may not request the UE to reduce the UL transmit power.

Alternatively, the UE may apply different pathloss values (e.g., PL_{b,f,c}(q_{d}) in equation (1)) for ACK s and NACKs. For instance, the UE may transmit a PUCCH signal carrying a NACK with transmit power boosting and subsequently transmits a PUCCH signal carrying an ACK. Upon receiving the NACK, the BS may send a TPC command to the UE to reduce the UL transmit power. Upon receiving the TPC command to reduce the UL transmit power, the UE may add the difference due to the power boosting applied at the pervious NACK transmission when determining a transmit power for the ACK transmission, for example, by adjusting the pathloss value.

While NACK transmit power boosting discussed above in can increase power consumptions at UEs, the increase in power consumption may be substantially small, especially in URLLC as URLLC traffic is often sparse.

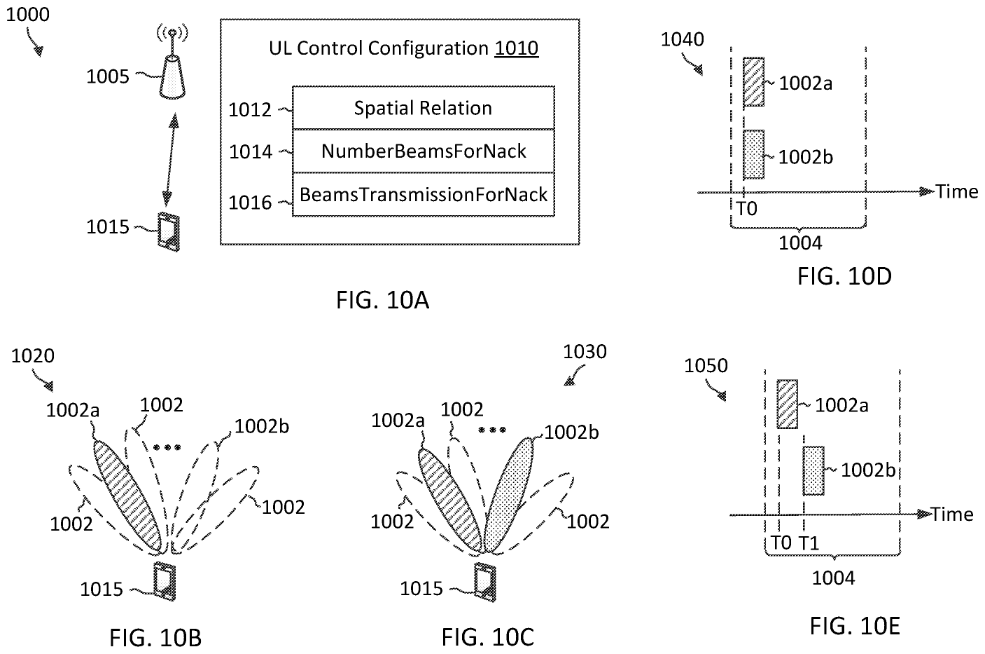

FIG. 10A is discussed in relation to FIGS. 10B-10E to illustrate a UL control channel transmission scheme 1000 that utilizes a greater narrowband number of beams for NACK transmissions than for ACK transmissions to increase the reliability of NACK transmissions. FIG. 10A illustrates a UL control channel configuration 1010 with a NACK-specific beam configuration according to some aspects of the present disclosure. FIG. 10B illustrates a UL control channel transmission scheme 1020 for an ACK transmission according to some aspects of the present disclosure. FIG. 10C illustrates a UL control channel transmission scheme 1030 for a NACK transmission according to some aspects of the present disclosure. FIG. 10D illustrates a UL control channel transmission scheme 1040 for a NACK transmission utilizing multiple beams simultaneously according to some aspects of the present disclosure. FIG. 10E illustrates a UL control channel transmission scheme 1050 for a NACK transmission with beam switching according to some aspects of the present disclosure. In FIGS. 10D and 10E, the x-axes may represent time in some arbitrary units. The scheme 1000 may be employed by BSs such as the BSs 105, 500, and/or 605 and UEs such as the UEs 115, 400 and/or 615 in a network such as the network 100. In the scheme 1000, a BS 1005 (e.g., the BSs 105, 500, and/or 605) may configure a UE 1015 (e.g., the UEs 115, 400, and/or 600) to use a greater number of beams for NACK transmissions than for ACK transmissions. For instance, the BS 1005 may configure the UE 1015 to transmit a NACK transmission using multiple beams and an ACK transmission using a single beam.

In the scheme 1000, the BS 1005 may configure the UE 1015 with a UL control channel configuration 1010 as shown in FIG. 10A. The configuration 1010 includes one or more spatial relation parameters 1012, a NumberBeamsforNACK parameter 1014, and a BeamTransmissionForNack parameter 1016. The spatial relation parameters 1012 may include parameters (e.g., a SSB index) substantially similar to the PUCCH-SpatialRelationlnfo information element described in the 3GPP document TS 38.331 Release 15, section 6.3.2. The SSB index may identify an SSB block within a SSB burst. For instance, the BS 1005 may transmit SSB blocks within an SSB bursts by sweeping through a number of beams (e.g., the beams 1002 shown in FIGS. 10B and 10C). During an initial network access, the UE 1015 may perform beam measurements on the SSBs received from the BS 1005. The UE 1015 may perform a beam selection procedure with the BS 1005 to select one or more beam directions (e.g., the beams 1002a and 1002b) that may provide the highest quality (e.g., strongest received signal strength) for the BS 1005 and the UE 1015 to communicate with each other. The selected beam direction(s) may be identified based on the beam index or the SSB index.

The NumberBeamsforNACK parameter 1014 may indicate a number of beams to be used for transmitting a PUCCH signal (e.g., the ACK/NACK signal 330) carrying a NACK. The NumberBeamsforNACK parameter 1014 can have any suitable integer values (e.g., between about 1 to about 4). The BeamTransmissionForNack parameter 1016 may indicate whether the multiple beams for the NACK transmission are to be transmitted simultaneously (shown in FIG. 10D) or sequentially in a beam switching manner (shown in FIG. 10E). The BeamTransmissionForNack parameter 1016 may also include beam directions or SSB indices to be used for a NACK transmission.

Referring to FIG. 10B, in the scheme 1020, when the UE 1015 transmits a PUCCH signal carrying an ACK to the BS (in response a DL data transmission), the UE 1015 may transmit the PUCCH signal using the selected beam 1002a.

Referring to FIG. 10C, in the scheme 1030, when the UE 1015 transmits a PUCCH signal carrying a NACK to the BS (in response to a DL data transmission), the UE 1015 may determine a number of beams for transmitting the PUCCH signal with the NACK based on the NumberBeamsforNACK parameter 1014 in the configuration 1010. As an example, the NumberBeamsforNACK parameter 1014 may be set to a value of 2 to indicate that a PUCCH transmission including a NACK is to be transmitted in two beam directions. Thus, the UE 1015 may transmit the PUCCH signal carrying the NACK using the two beams with the highest quality selected during the beam sweeping and selection procedure. For instance, the two highest quality beams are beams 1002a and 1002b selected from the beam selection procedure. Thus, the UE 1015 may transmit a first PUCCH signal carrying the NACK using the selected beam 1002a and a second PUCCH signal carrying the NACK using the other selected beam 1002b. In some other instances, BeamTransmissionForNack parameter 1016 may indicate the beam directions (e.g., the beams 1002a and 1002b) to be used for a multi-beam NACK transmission.

Referring to FIG. 10D, in the scheme 1040, the UE 1015 may transmit the first PUCCH signal (carrying the NACK) using the beam 1002a and the second PUCCH signal (carrying the NACK) using the beam 1002b simultaneously beginning at time TO during a time period 1004 (e.g., a slot 202) when the BeamTransmissionForNack parameter 1016 indicates that the multiple beams for NACK transmissions are to be transmitted simultaneously. For instance, the UE 1015 may have multi-panel antenna elements and is capable of transmitting multiple beams simultaneously. Thus, at time TO, the UE 1015 configure a frontend (e.g., the RF unit 414 and the antennas 416) of the UE 1015 to transmit the first PUCCH signal (carrying the NACK) using the beam 1002a and the second PUCCH signal (carrying the NACK) using the beam 1002b simultaneously.

Referring to FIG. 10E, in the scheme 1050, the UE 1015 may transmit the first PUCCH signal (carrying the NACK) using the beam 1002a and the second PUCCH signal (carrying the NACK) using the beam 1002b in consecutive time periods during a time period 1004 (e.g., a slot 202) when the BeamTransmissionForNack parameter 1016 indicates that the multiple beams for NACK transmissions are to be transmitted in a beam-switching manner. For instance, at time TO, the UE 1015 may configure the frontend (e.g., the RF unit 414 and the antennas 416) to transmit the first PUCCH signal (carrying the NACK) using the beam 1002a. At time T1, the UE 10105 may configure the frontend to switch to the beam 1002b direction and transmit the second PUCCH signal (carrying the NACK) using the beam 1002b. The scheme 1050 may be suitable for UEs with single panel antenna elements, and thus may not be capable of transmitting multiple beams at the same time.

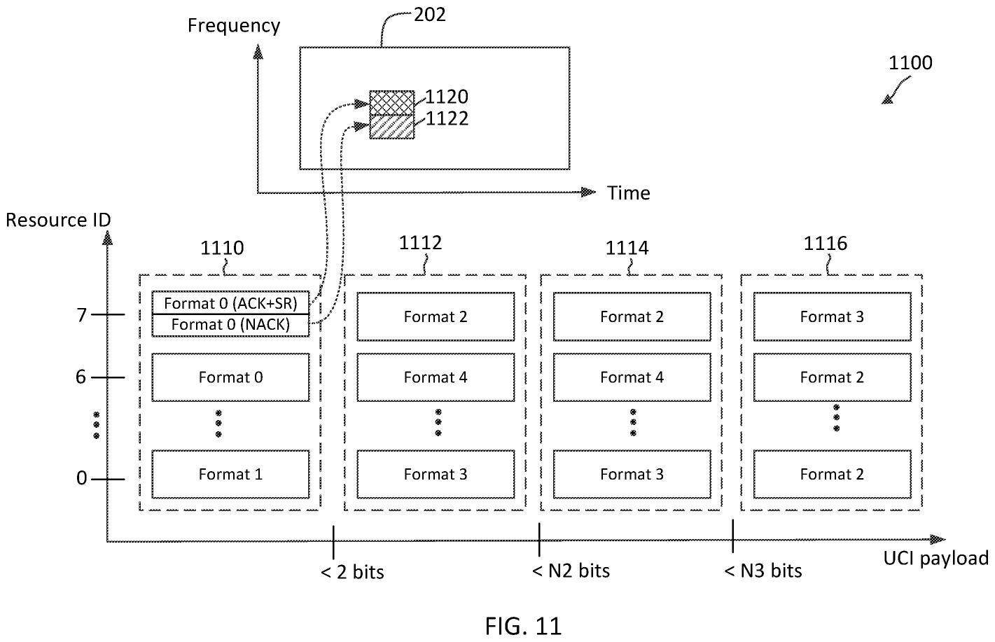

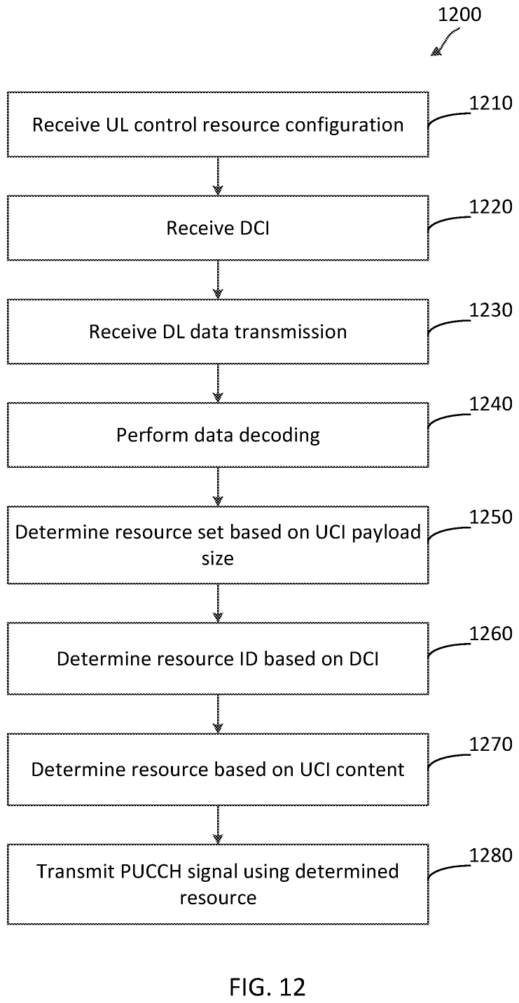

FIGS. 11-12 illustrate various mechanisms for utilizing different resources for ACK/NACK transmissions. FIG. 11 illustrates a UL control channel resource configuration 1100 according to some aspects of the present disclosure. The configuration 1100 may be employed by BSs such as the BSs 105, 500, and/or 605 and UEs such as the UEs 115, 400 and/or 615 in a network such as the network 100. In FIG. 11, the x-axis represents UCI payload size in units of bits, and the y-axis represents resource ID. The configuration 1100 may be used in conjunction with the scheme 600, 700, and/or 1000 discussed above with reference to FIGS. 6, 7, and/or 10, respectively, where transmit power boosting is applied to NACK transmissions. The configuration 1100 may be substantially similar to the scheme 600. However, in the configuration 1100, a BS (e.g., the BSs 105, 500, 605, and/or 1005) may configure a UE (e.g., the UEs 115, 400, 615, and/or 1015) with different, separate resources for ACK transmission and NACK transmissions.

For instance, the BS may configure the UE with multiple PUCCH resource sets 1110, 1112, 1114, and 1116, which may be substantially similar to the resource sets 624a, 624b, 624c, and 624d, respectively. However, a resource set can include multiple resources with the same resource ID 1102. In the illustrated example of FIG. 11, the resource set 1110 indicates two resources 1120 and 1122 with the resource ID 7. The resources 1120 and 1122 may be located in the same slot 202 and/or same symbol (e.g., symbols 206), but may in different PRBs (e.g., the RBs 210). As shown, the resource 1120 is for PUCCH format 0 transmission with ACK and SR, and the resource 1122 is for PUCCH format 0 transmission with NACK-only. Thus, the UE may select a resource for a PUCCH transmission based on the UCI content as discussed further in FIG. 12.

In some aspects, a PUCCH format 0_0 and a PUCCH format 1_0 may be defined for NACK-only transmissions. The PUCCH format 0_0 may be similar to the PUCCH format 0. The PUCCH format 1_0 may be similar to the PUCCH format 1. For instance, a PUCCH format 0 may be as described in the 3GPP document 38.331 and shown below:

| | |
|---|---|
| PUCCH-format0 ::= | SEQUENCE { |
| initialCyclicShift | INTEGER(0..11), |
| nrofSymbols | INTEGER (1..2), |
| startingSymbolIndex | INTEGER(0..13) |

}.

The initialCylicShift refers to the cyclic shift to be used to generate a PUCCH sequence. The nrofSymbols refers to the number of symbols to be used for transmitting the PUCCH sequence. The startingSymbollndex refers to the starting symbol index within a slot for transmitting the PUCCH sequence, where the slot may be based on the scheduling DCI.

A PUCCH format 0_0 may be defined for NACK-only transmission as shown below:

| | |
|---|---|
| PUCCH-format0_0 ::= | SEQUENCE { |
| initialCyclicShift | INTEGER(0..3, 7, 11), |
| nrofSymbols | INTEGER (1), |
| startingSymbolIndex | INTEGER(0..13) |

}.

As shown, the PUCCH format 0_0 for the NACK-only transmission may have a more restricted set of initial cyclic shift (e.g., values of 0 to 3, 7, or 11) than the PUCCH format 0 and may only be transmitted using one symbol instead of two symbols. For instance, in the configuration 1100, the resource set 1110 may indicate the PUCCH format 0 for the NACK-only transmission using the PUCCH-format 0_0.

A PUCCH format 1 be as described in the 3GPP document 38.331 and shown below:

| | |
|---|---|
| PUCCH-format1 ::= | SEQUENCE { |
| initialCyclicShift | INTEGER(0..11), |
| nrofSymbols | INTEGER (4..14), |
| startingSymbolIndex | INTEGER(0..10), |
| timeDomainOCC | INTEGER(0..6) |

}.

The timeDomainOCC may refered to a time domain orthogonal cover code (OCC) for CDM in a time domain.

A PUCCH format 1_0 may be defined for NACK-only transmission as shown below:

| | |
|---|---|
| PUCCH-format1_0 ::= | SEQUENCE { |
| initialCyclicShift | INTEGER(0, 3, 7, 11), |
| nrofSymbols | INTEGER (4..14), |
| startingSymbolIndex | INTEGER(0..10) |

}.

As shown, the PUCCH format 1_0 for the NACK-only transmission may have a more restricted set of initial cyclic shift (e.g., values of 0, 3, 7, or 11) than the PUCCH format 1 and may not apply CDM (e.g., without timeDomainOCC).

In some aspects, the location of a PUCCH format 0 resource and/or PUCCH format 1 resource in a slot (e.g., the slot 202) may be predetermined. For instance, the BS may expect an ACK/NACK feedback at the same symbol location (e.g., the symbols 206) within a slot. In some aspects, the resources for PUCCH format 0_0 and PUCCH format 1_0 can be exchanged among neighboring BSs, for example, via a Xn application (XnAP) interface. The exchange of the PUCCH format 0 0 and PUCCH format 1 0 resource information can be useful for inter-cell interference coordination (ICIC) since the PUCCH format 0_0 and PUCCH format 1_0 are used for NACK-only transmissions with transmit power boosting. The higher transmission power can cause a higher interference, which may impact cell-edge performances.

FIG. 12 is a flow diagram of a UL control channel resource determination method 1200 according to some aspects of the present disclosure. Aspects of the method 1200 can be executed by a computing device (e.g., a processor, processing circuit, and/or other suitable component) of a wireless communication device or other suitable means for performing the steps. For example, a wireless communication device, such as the UEs 115, 400, 615, and/or 1015 may utilize one or more components, such as the processor 402, the memory 404, the PUCCH module 408, the transceiver 410, the modem 412, and the one or more antennas 416, to execute the steps of method 1200. As illustrated, the method 1200 includes a number of enumerated steps, but aspects of the method 1200 may include additional steps before, after, and in between the enumerated steps. In some aspects, one or more of the enumerated steps may be omitted or performed in a different order. The method 1200 may be implemented in conjunction with the configuration 1100 when different specific resources are assigned for PUCCH transmissions with ACKs and PUCCH transmissions with NACKs. The method 1200 is described in relation to FIG. 11.

At block 1210, the UE receives a UL control resource configuration from a BS (e.g., the BSs 105, 500, 605, and/or 1015). The UL control resource configuration may correspond to the UL control resource configuration 1100. In some instances, the UE may utilize one or more components, such as the processor 402, the memory 404, the PUCCH module 408, the transceiver 410, the modem 412, and the one or more antennas 416, to receive the UL control resource configuration. The UE may store the UL control resource configuration in a memory such as the memory 404.

At block 1220, the UE receives DCI indicating scheduling information for a DL data transmission and a PUCCH resource (e.g., a resource ID as shown in the y-axis FIG. 11) for an ACK/NACK transmission. In some instances, the UE may utilize one or more components, such as the processor 402, the memory 404, the PUCCH module 408, the transceiver 410, the modem 412, and the one or more antennas 416, to receive the DCI.

At block 1230, the UE receives the DL data transmission from the BS according to the scheduling information for the DL data transmission. In some instances, the UE may utilize one or more components, such as the processor 402, the memory 404, the PUCCH module 408, the transceiver 410, the modem 412, and the one or more antennas 416, to receive the DL data transmission.

At block 1240, the UE performs data decoding on the received DL data transmission. The decoding status is an ACK when the decoding is successful. The decoding status is a NACK when the decoding fails. In some instances, the UE may utilize one or more components, such as the processor 402, the memory 404, the PUCCH module 408, the transceiver 410, the modem 412, and the one or more antennas 416, to perform the data decoding, for example, based on a MCS indicated by the DCI.

At block 1250, the UE determines a resource set from the resource sets (e.g., the resource sets 1110, 1112, 1114, 1116 of FIG. 11) indicated by the UL control channel resource configuration based on a UCI payload for carrying the ACK/NACK status. In some instances, the UE may utilize one or more components, such as the processor 402, the memory 404, the PUCCH module 408, the transceiver 410, the modem 412, and the one or more antennas 416, to determine the UCI payload size (e.g., based on whether an ACK or a NACK and whether other UCI can be multiplexed) and determine the resource set from the resource sets indicated by the UL control channel resource configuration based on the UCI payload size. For instance, the UCI payload size may be less than 2 bits, and thus the UE may select the resource set 1110.

At block 1260, the UE determines a resource ID based on the DCI. For instance, the DCI indicates a resource ID of 7. In some instances, the UE may utilize one or more components, such as the processor 402, the memory 404, the PUCCH module 408, the transceiver 410, the modem 412, and the one or more antennas 416, to determine the resource ID based on the DCI.

At block 1270, the UE determines a resource based on the UCI content. In some instances, the UE may utilize one or more components, such as the processor 402, the memory 404, the PUCCH module 408, the transceiver 410, the modem 412, and the one or more antennas 416, to determine the resource based on the UCI content. For instance, if the decoding status at block 1240 is an ACK, the UE may select the resource 1120 identified by the resource ID 7 in the resource set 1110. In some instances, when the decoding status is an ACK, the UE may further include an SR in the UCI payload. If the decoding status at block 1240 is a NACK, the UE may select the resource 1122 identified by the resource ID 7 in the resource set 1110. If the UE determines to use the resource 1122 for a NACK-only transmission, the UE may not include other UCI, such as an SR or CSI, in the UCI payload.

At block 1280, the UE transmits a PUCCH signal carrying the UCI in the determined resource. In some instances, the UE may utilize one or more components, such as the processor 402, the memory 404, the PUCCH module 408, the transceiver 410, the modem 412, and the one or more antennas 416, to transmit the PUCCH signal carrying the UCI in the determined resource.

While utilizing different, separate resources for ACK transmissions and for NACK transmissions can increase UL resource usages and eventually increase UE energy consumption, the increase in UE energy consumption may be substantially small especially for URLLC since URLLC traffic may be sparse.

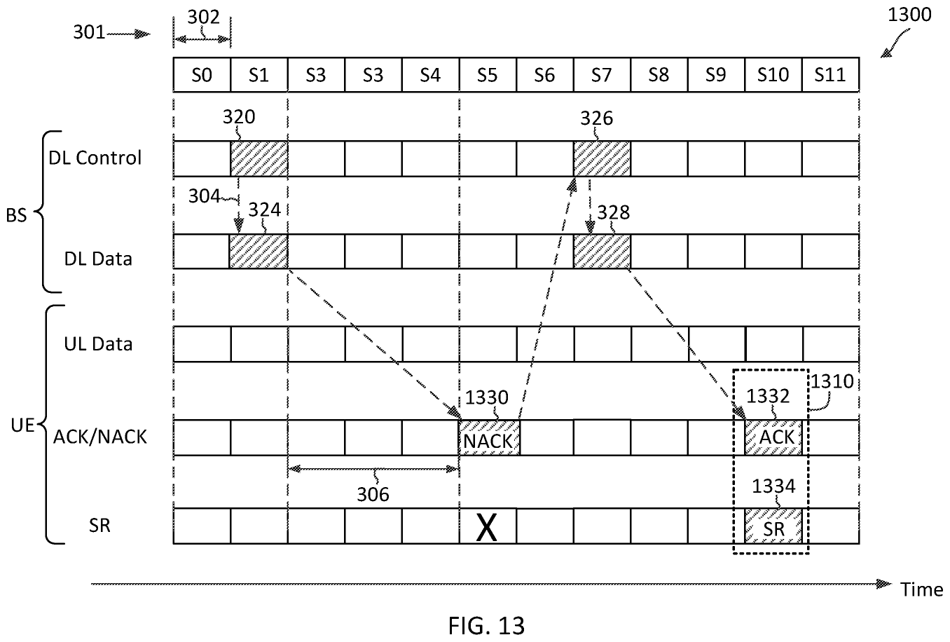

FIG. 13 illustrates a UL control channel transmission scheme 1300 according to some aspects of the present disclosure. The scheme 1300 may be employed by BSs such as the BSs 105, 500, and/or 605 and UEs such as the UEs 115, 400 and/or 615 in a network such as the network 100. In FIG. 13, the x-axis represents time in some arbitrary units. The scheme 1300 can be implemented in conjunction with the schemes 600 and/or 700 discussed above with respect to FIGS. 6 and/or 7, respectively. In the scheme 1300, a BS (e.g., the BSs 105, 500, 605, and/or 1005) may restrict a UE (e.g., the UEs 115, 400, 615, and/or 1015) to transmit NACK-only UCI for certain PUCCH formats (e.g., PUCCH format 0 and PUCCH format 1) with transmit power boosting as discussed above in the configuration 1100 with reference to FIG. 11. In some other instances, the BS may allow the UE to transmit an ACK using PUCCH format 2, but may not allow the UE to transmit a NACK using PUCCH format 2. The scheme 1300 is described using the same scheduling timeline as in the scenario 300, and may use the same reference numerals as in FIG. 3 for simplicity's sake.

In the illustrated example of FIG. 13, the UE fails to decode the DL data signal 324, thus the UE may feedback a NACK to the BS. If the UE is to transmit the NACK with transmit power boosting, the UE may not multiplex another UCI (e.g., an SR) with the NACK. As shown, the UE transmits the ACK/NACK signal 1330 (e.g., the ACK/NACK signal 330) carrying a NACK for the DL data signal 324 without including an SR (as shown by the cross). If the UE has data to be sent to the BS, the UE may wait till the next PUCCH occasion or opportunity to send an SR. For instance, the UE may successfully decode the DL data signal 328 (e.g., a retransmission of DL data in the DL data signal 324), and thus may transmit an ACK to the BS. Since the UE is going to transmit an ACK, the UE may also transmit an SR along with the ACK. As shown, the UE transmits a PUCCH signal 1310 including an ACK 1332 for the DL data signal 328 and an SR 1332. As can be seen, the UE delays the transmission of an SR until a PUCCH opportunity that allows for SR multiplexing.

In some aspects, the BS may restrict how often the UE may transmit an SR, for example, by configuring the UE with an SR prohibition timer. For instance, the UE may start the SR prohibition timer after transmitting an SR. When the SR prohibition timer is running, the UE may not be allowed to transmit an SR. To facilitate transmission of SR when the UE is configured with NACK-only PUCCH transmissions, the BS may configure the UE with a more relax SR prohibition timer (e.g., with a shorter timeout) to account for the NACK-only transmissions with no SR opportunity.

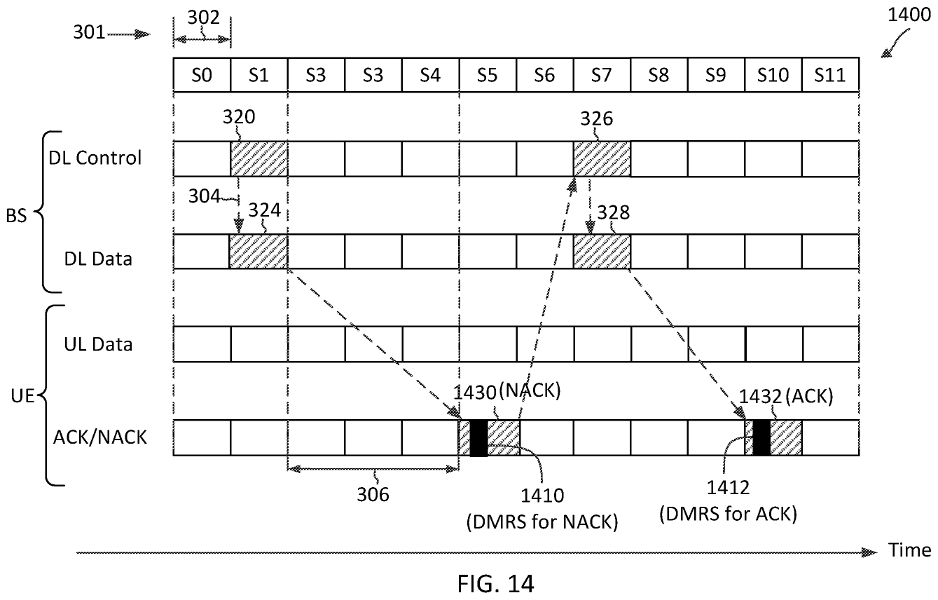

FIG. 14 illustrates a UL control channel transmission scheme 1400 according to some aspects of the present disclosure. The scheme 1400 may be employed by BSs such as the BSs 105, 500, and/or 605 and UEs such as the UEs 115, 400 and/or 615 in a network such as the network 100. In FIG. 14, the x-axis represents time in some arbitrary units. The scheme 1400 can be implemented in conjunction with the schemes 600 and/or 700 discussed above with respect to FIGS. 6 and/or 7, respectively. In the scheme 1400, a BS (e.g., the BSs 105, 500, 605, and/or 1005) may configure a UE (e.g., the UEs 115, 400, 615, and/or 1015) with different DMRS sequences for ACK transmissions and for NACK transmissions, for example, in PUCCH format 1. For instance, the BS may configure the UE with a DMRS sequence 1410 for NACK transmissions and a DMRS sequence 1412 for ACK transmissions. The DMRS sequence 1410 is different from the DMRS sequence 1412. For instance, the DMRS sequence 1410 and the DMRS sequence 1412 may have different sequence roots, different cyclic shifts, and/or different base sequences.

In the illustrated example of FIG. 14, the UE fails to decode the DL data signal 324, thus the UE may transmit a NACK to the BS. The UE may transmit an ACK/NACK signal 1430 including the DMRS 1410 to indicate the NACK. Thus, the ACK/NACK signal 1430 may be a UCI-content less signal. Upon receiving the ACK/NACK signal 1430, the BS may determine whether the ACK/NACK signal 1430 indicates a NACK or an ACK based on the DMRS sequence in the ACK/NACK signal 1430. For instance, if the BS detected a DMRS sequence 1410 in the ACK/NACK signal 1430, the BS may determine that the indication is a NACK.

Upon receiving the NACK indication, the BS may retransmit the DL data in the DL data signal 324 as discussed above. For instance, the UE may successfully decode the retransmission (e.g., DL data signal 328). Thus, the UE may transmit an ACK/NACK signal 1432 including the DMRS 1412 to indicate the ACK. Thus, the ACK/NACK signal 1430 may be a UCI-content less signal. Similarly, upon receiving the ACK/NACK signal 1432, the BS may determine whether the ACK/NACK signal 1432 indicates a NACK or an ACK based on the DMRS sequence in the ACK/NACK signal 1432. For instance, if the BS detected a DMRS sequence 1412 in the ACK/NACK signal 1432, the BS may determine that the indication is an ACK.

In some aspects, the ACK/NACK signals 1430 and 1432 are PUCCH format 1 signals. The use of different DMRS sequences for ACK indications and NACK indications may be an expansion of PUCCH format 0 (where different based sequences are used to indicate different UCI indications) to a greater number of symbols. For instance, a PUCCH format 1 signal may occupy between about 4 symbols to about 14 symbols, whereas a PUCCH format 0 signal may occupy 1 or 2 symbols. Since the BS may determine whether an ACK/NACK signal indicates an ACK or a NACK based on a DMRS sequence detection without decoding the signal, the scheme 1400 can provide a lower communication latency.

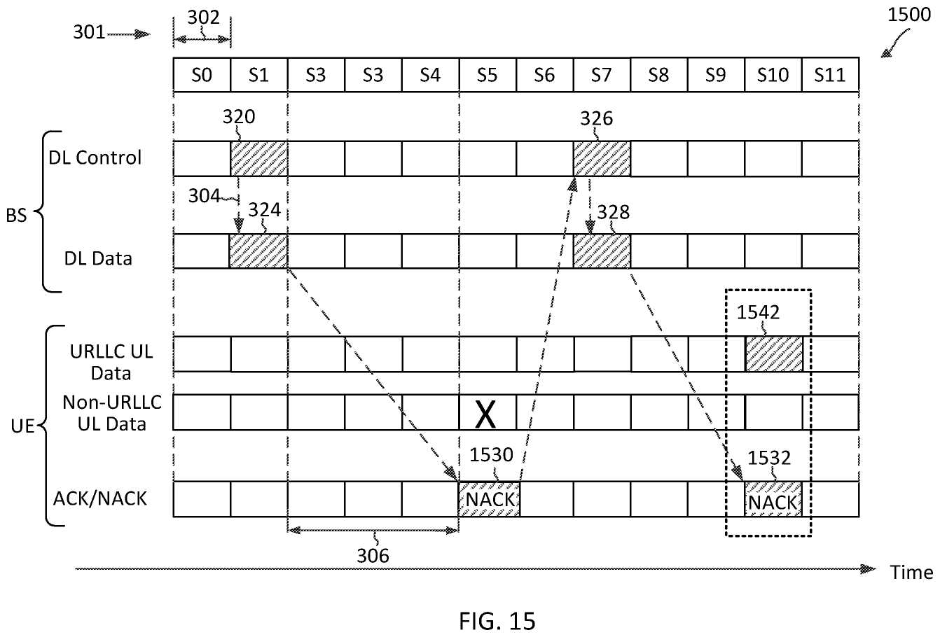

FIG. 15 illustrates a UL transmission scheme 1500 according to some aspects of the present disclosure. The scheme 1500 may be employed by BSs such as the BSs 105, 500, and/or 605 and UEs such as the UEs 115, 400 and/or 615 in a network such as the network 100. In FIG. 15, the x-axis represents time in some arbitrary units. The scheme 1500 can be implemented in conjunction with the schemes 600 and/or 700 discussed above with respect to FIGS. 6 and/or 7, respectively. In the scheme 1500, a BS (e.g., the BSs 105, 500, 605, and/or 1005) may restrict a UE (e.g., the UEs 115, 400, 615, and/or 1015) in multiplexing UL data (e.g., PUSCH) with a NACK-only transmission. For instance, the BS may allow the UE to multiplex a NACK-only UCI with a URLLC data, but not with non-URLLC data. The scheme 1500 is described using the same scheduling timeline as in the scenario 300, and may use the same reference numerals as in FIG. 3 for simplicity's sake.

In the illustrated example of FIG. 15, the UE fails to decode the DL data signal 324, thus the UE may feedback a NACK to the BS. If the UE has UL data (e.g., PUSCH data) to be sent to the BS, the UE may determine whether to multiplex the PUSCH data with the NACK-only UCI based on whether the UL data is URLLC data or not. If the PUSCH data is non-URLLC data, the UE may drop the PUSCH (shown by the cross) and transmit the NACK-only transmission 1530 to the BS.

Upon receiving the NACK-only transmission 1530, the BS may retransmit the DL data in the DL data signal 324 as discussed above. For instance, the UE may fail to decode the retransmission (e.g., DL data signal 328). Thus, the UE may again feedback a NACK to the BS. If the UE has URLLC data 1542 (e.g., PUSCH data) to be sent to the BS and UL schedule coincides with the NACK feedback schedule, the UE may multiplex the URLLC data 1542 with the NACK-only UCI, for example, in an UL transmission with transmit power boosting, to the BS.

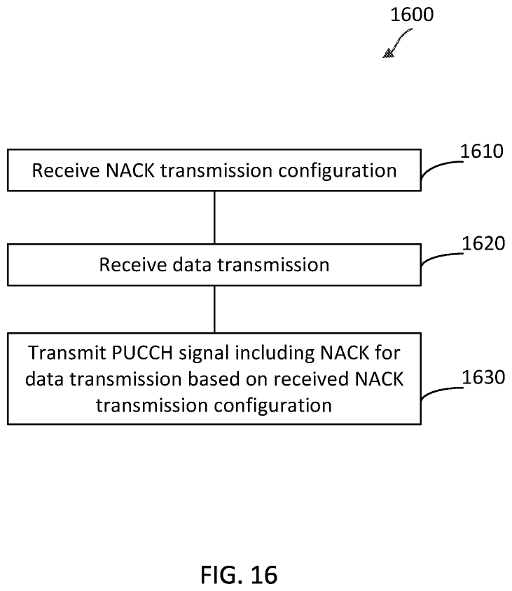

FIG. 16 is a flow diagram of a wireless communication method 1600 according to some aspects of the present disclosure. Aspects of the method 1600 can be executed by a computing device (e.g., a processor, processing circuit, and/or other suitable component) of a wireless communication device or other suitable means for performing the steps. For example, a wireless communication device, such as the UEs 115, 400, 615, and/or 1015 may utilize one or more components, such as the processor 402, the memory 404, the PUCCH module 408, the transceiver 410, the modem 412, and the one or more antennas 416, to execute the steps of method 1600. The method 1600 may employ similar mechanisms as in the schemes 600, 700, 1000, 1100, 1300, 1400, 1500, described above with respect to FIGS. 6A-6C, 7A-7D, 10A-10E, 11, 13, and/or 14, respectively, and/or the method 1200 described above with respect to FIG. 12. As illustrated, the method 1600 includes a number of enumerated steps, but aspects of the method 1600 may include additional steps before, after, and in between the enumerated steps. In some aspects, one or more of the enumerated steps may be omitted or performed in a different order.

At block 1610, a UE (e.g., the UEs 115, 400, 615, and/or 1015) receives a NACK transmission configuration from a BS (e.g., the BSs 105, 500, 605, and/or 1005). In some instances, the UE may utilize one or more components, such as the processor 402, the PUCCH module 408, the transceiver 410, and the RF unit 414, to receive the NACK transmission configuration.

At block 1620, the UE receives a data transmission (e.g., the DL data signal 324 and/or 328) from the BS. In some instances, the UE may utilize one or more components, such as the processor 402, the memory 404, the PUCCH module 408, the transceiver 410, the modem 412, and the one or more antennas 416, to receive the data transmission.

At block 1630, the UE transmits, to the BS, a PUCCH signal including a NACK for the data transmission based on the received NACK transmission configuration. In some instances, the UE may utilize one or more components, such as the processor 402, the memory 404, the PUCCH module 408, the transceiver 410, the modem 412, and the one or more antennas 416, to transmit the PUCCH signal.

In some aspects, the NACK transmission configuration at block 1610 may include a flag (e.g., TxPowerBoostingForNack flags 712, 810, 912, 922, 932, 942, and 952) indicating whether to increase or boost a transmit power of the PUCCH signal when the PUCCH signal includes the NACK. In some aspects, the NACK transmission configuration may include a plurality of transmit power parameters (for boosting a transmit power), where each transmit power parameter may be associated with a logical channel (e.g., the logical channels 802 and 902) and/or a PUCCH format (e.g., PUCCH format 0, PUCCH format 1, PUCCH format 2, PUCCH format 3, or PUCCH format 4), for example, as shown in the configurations 800 and/or 900 discussed above with reference to FIGS. 8A and/or 9A, respectively, and/or the information elements 730, 740, 820, 960 discussed above with references to FIGS. 7C, 7D, 8B, and/or 9B, respectively. Accordingly, the PUCCH signal at block 1630 may be transmitted with transmit power boosting.

In some aspects, the NACK transmission configuration at block 1610 may include one or more beam parameters (e.g., the parameters 1014 and 1016 in the configuration 1010). The PUCCH signal at block 1630 can be transmitted in multiple beam directions sequentially or simultaneously based on the one or more beam parameters, for example, as shown in the scheme 1000 discussed above with reference to FIG. 10.

In some aspects, the NACK transmission configuration at block 1610 may indicate a NACK resource allocation different from an ACK resource allocation, for example, as shown in the configuration 1100 discussed above with reference to FIG. 11. Accordingly, the PUCCH signal at block 1630 may be transmitted using a NACK-specific resource indicated by the NACK resource allocation.

In some aspects, the PUCCH signal transmitted at block 1630 may be a NACK-only transmission without other UCI.

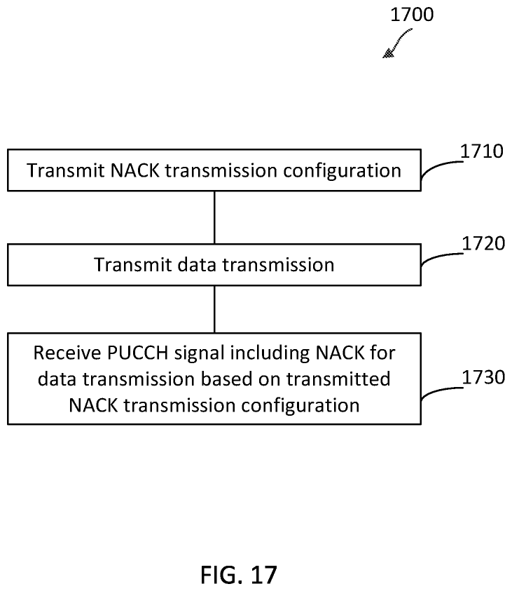

FIG. 17 is a flow diagram of a wireless communication method 1700 according to some aspects of the present disclosure. Aspects of the method 1700 can be executed by a computing device (e.g., a processor, processing circuit, and/or other suitable component) of a wireless communication device or other suitable means for performing the steps. For example, a wireless communication device, such as the BSs 105, 500, 605, and/or 1005 may utilize one or more components, such as the processor 502, the memory 504, the PUCCH module 508, the transceiver 510, the modem 512, and the one or more antennas 516, to execute the steps of method 1600. The method 1700 may employ similar mechanisms as in the schemes 600, 700, 1000, 1100, 1300, 1400, 1500, described above with respect to FIGS. 6A-6C, 7A-7D, 10A-10E, 11, 13, and/or 14, respectively, and/or the method 1200 described above with respect to FIG. 12. As illustrated, the method 1700 includes a number of enumerated steps, but aspects of the method 1700 may include additional steps before, after, and in between the enumerated steps. In some aspects, one or more of the enumerated steps may be omitted or performed in a different order.

At block 1710, a BS (e.g., the BSs 105, 500, 605, and/or 1005) transmits a NACK transmission configuration to a UE (e.g., the UEs 115, 400, 615, and/or 1015). In some instances, the BS may utilize one or more components, such as the processor 502, the memory 504, the PUCCH module 508, the transceiver 510, the modem 512, and the one or more antennas 516, to receive the NACK transmission configuration.

At block 1720, the BS transmits a data transmission (e.g., the DL data signal 324 and/or 328) to the UE. In some instances, the BS may utilize one or more components, such as the processor 502, the memory 504, the PUCCH module 508, the transceiver 510, the modem 512, and the one or more antennas 516, to receive the data transmission.

At block 1730, the BS receives, from the UE, a PUCCH signal including a NACK for the data transmission based on the received NACK transmission configuration. In some instances, the BS may utilize one or more components, such as the processor 502, the memory 504, the PUCCH module 508, the transceiver 510, the modem 512, and the one or more antennas 516, to transmit the PUCCH signal.

In some aspects, the NACK transmission configuration at block 1710 may include a flag (e.g., TxPowerBoostingForNack flags 712, 810, 912, 922, 932, 942, and 952) indicating whether to increase or boost a transmit power of the PUCCH signal when the PUCCH signal includes the NACK. In some aspects, the NACK transmission configuration may include a plurality of transmit power parameters (for boosting a transmit power), where each transmit power parameter associated with a logical channel (e.g., the logical channels 802 and 902) and/or a PUCCH format (e.g., PUCCH format 0, PUCCH format 1, PUCCH format 2, PUCCH format 3, or PUCCH format 4), for example, as shown in the configurations 800 and/or 900 discussed above with reference to FIGS. 8A and/or 9A, respectively, and/or the information elements 730, 740, 820, 960 discussed above with references to FIGS. 7C, 7D, 8B, and/or 9B, respectively. Accordingly, the PUCCH signal at block 1630 may be transmitted with transmit power boosting.

In some aspects, the NACK transmission configuration at block 1710 may include one or more beam parameters (e.g., the parameters 1014 and 1016 in the configuration 1010). The PUCCH signal at block 1730 can be received in multiple beam directions sequentially or simultaneously based on the one or more beam parameters, for example, as shown in the scheme 1000 discussed above with reference to FIG. 10.

In some aspects, the NACK transmission configuration at block 1710 may indicate a NACK resource allocation different from an ACK resource allocation, for example, as shown in the configuration 1100 discussed above with reference to FIG. 11.

In some aspects, the PUCCH signal received at block 1730 may be a NACK-only transmission without other UCI.

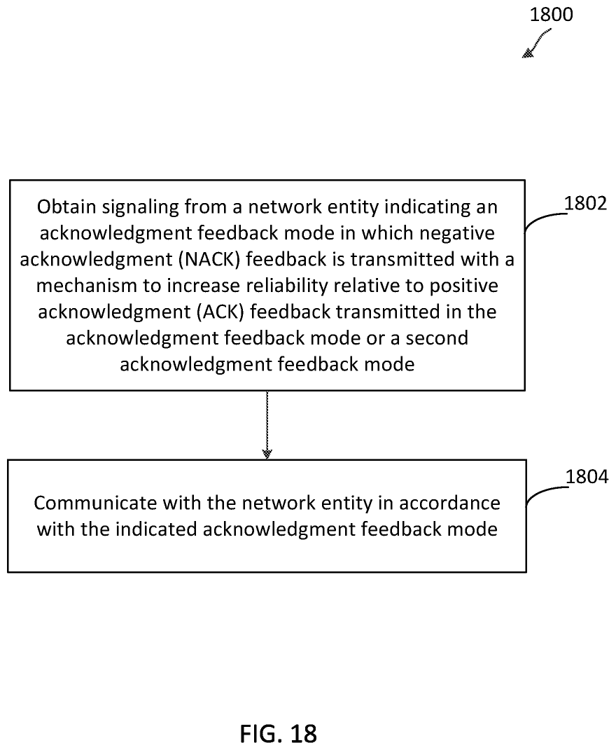

FIG. 18 is a flow diagram of a wireless communication method 1800 according to some aspects of the present disclosure. Aspects of the method 1800 can be executed by a computing device (e.g., a processor, processing circuit, and/or other suitable component) of a wireless communication device or other suitable means for performing the steps. For example, a wireless communication device, such as the UEs 115, 400, 615, and/or 1015 may utilize one or more components, such as the processor 402, the memory 404, the PUCCH module 408, the transceiver 410, the modem 412, and the one or more antennas 416, to execute the steps of method 1800. In some examples, one or more UEs 115 in the network 100 may be configured to perform communication method 1800 of FIG. 18 to process an indication of an acknowledgment feedback mode. As illustrated, the method 1800 includes a number of enumerated steps, but aspects of the method 1800 may include additional steps before, after, and in between the enumerated steps. In some aspects, one or more of the enumerated steps may be omitted or performed in a different order.

At block 1802, a UE (e.g., the UEs 115, 400, 615, and/or 1015) obtains signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode. In some instances, the UE may utilize one or more components, such as the processor 402, the memory 404, the PUCCH module 408, the transceiver 410, the modem 412, and the one or more antennas 416, to obtain the signaling from the network entity indicating the acknowledgment feedback mode.

At block 1804, the UE communicates with the network entity in accordance with the indicated acknowledgment feedback mode. In other words, the UE may provide feedback for downlink transmissions in accordance with the indicated acknowledgment feedback mode (e.g., ACK/NACK or NACK only with high reliability NACK). In some instances, the UE may utilize one or more components, such as the processor 402, the memory 404, the PUCCH module 408, the transceiver 410, the modem 412, and the one or more antennas 416, to communicate with the network entity in accordance with the indicated acknowledgment feedback mode.

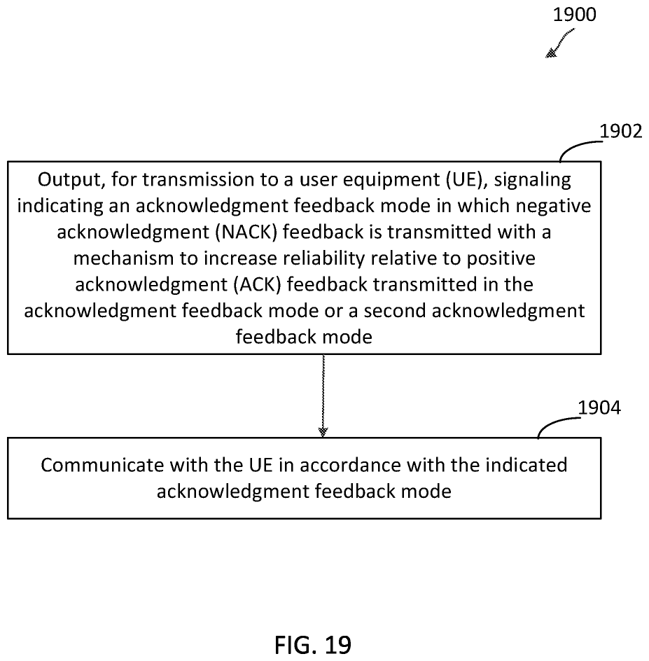

FIG. 19 is a flow diagram of a wireless communication method 1900 according to some aspects of the present disclosure. Aspects of the method 1900 can be executed by a computing device (e.g., a processor, processing circuit, and/or other suitable component) of a wireless communication device or other suitable means for performing the steps. For example, a wireless communication device, such as the BSs 105, 500, 605, and/or 1005 may utilize one or more components, such as the processor 502, the memory 504, the PUCCH module 508, the transceiver 510, the modem 512, and the one or more antennas 516, to execute the steps of method 1900. In some examples, one or more BSs 105 (e.g., gNBs) in the network 100 may be configured to perform communication method 1900 of FIG. 19 to signal an indication of an acknowledgment feedback mode (to a UE 115 performing operations 1800 of FIG. 18). As illustrated, the method 1900 includes a number of enumerated steps, but aspects of the method 1900 may include additional steps before, after, and in between the enumerated steps. In some aspects, one or more of the enumerated steps may be omitted or performed in a different order.

At block 1902, a network entity (e.g., the BSs 105, 500, 605, and/or 1005) outputs, for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode.

At block 1904, the network entity communicates with the UE in accordance with the indicated acknowledgment feedback mode. In other words, the network entity may monitor for feedback for downlink transmissions provided by the UE in accordance with the indicated acknowledgment feedback mode (e.g., ACK/NACK or NACK only with high reliability NACK).

There are various options for signaling the indication of the acknowledgment feedback mode. For example, these options may include signaling via DCI signaling, MAC control element (MAC CE) signaling, or RRC signaling.

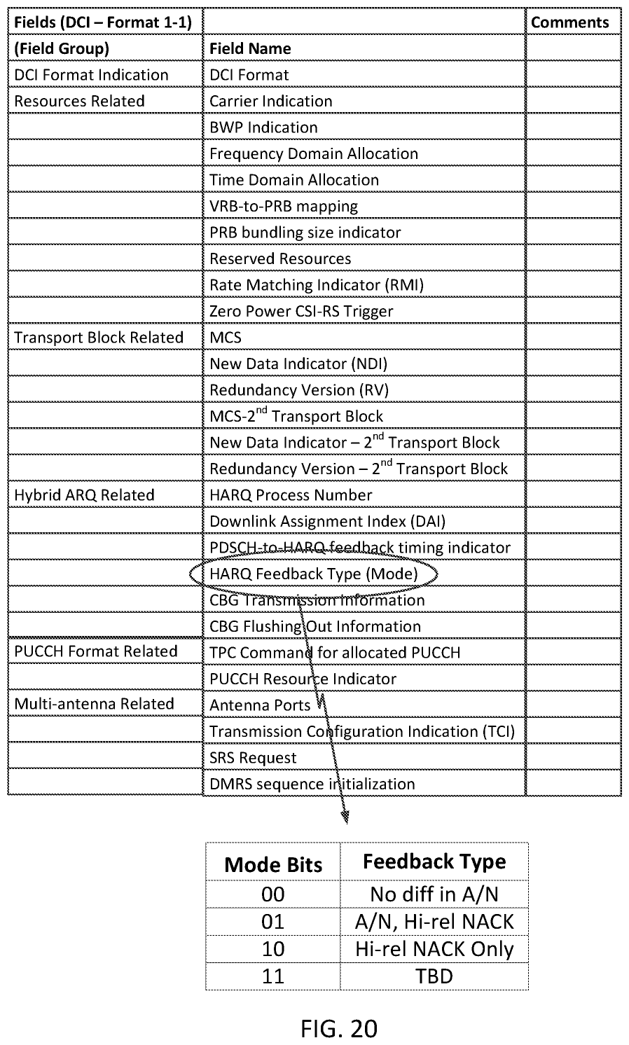

FIG. 20 illustrates an example DCI with a field for indicating changes to an acknowledgment feedback mode in accordance with various aspects of the disclosure. The DCI format shown in FIG. 20 may correspond to an existing DCI format 1-1 used (as a DL grant) to schedule a PDSCH transmission. A similar field may also be provided, however, in other DCI formats, such as DCI format 1-0 (also to schedule PDSCH transmissions) or DCI formats 0-0 or 0-1 (to schedule PUSCH transmissions).

As illustrated, the field used to indicate the acknowledgment feedback mode may be referred to as a HARQ Feedback Type field. As illustrated, using 2 bits, the field may indicate one of four acknowledgment feedback modes. In the example table shown in FIG. 20, the 2 bits may be used to indicate:
00: a first (regular) mode where ACK and NACK feedback are transmitted with regular (non-enhanced) reliability;
01: a second mode where both ACK and NACK feedback are transmitted, with NACK transmitted with enhanced reliability;
10: a third mode where only NACK is transmitted and with enhanced reliability; and
11: a reserved value that may be used for fourth mode.

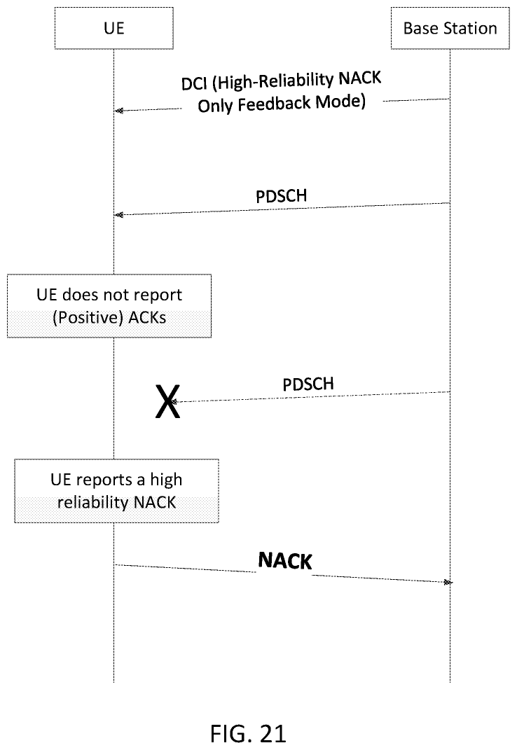

FIG. 21 illustrates an example call flow diagram for processing signaling indicating changes to an acknowledgment feedback mode provide via DCI (such as that shown in FIG. 20). In the illustrated example, the BS sends a DCI with an indication to use NACK only feedback with high reliability NACK transmissions (e.g., mode 10). In this mode, the UE does not provide positive acknowledgment (ACKs) for successfully decoded PDSCH transmissions.

If a PDSCH transmission is not successfully decoded, the UE may report a NACK using some high reliability mechanism. The mechanism to increase reliability may include, for example, increased transmission power, the use of at least one of different time resources or frequency resources, transmitting the NACK feedback with repetition, and/or transmitting the NACK feedback on an uplink channel without multiplexing other signals therein. Repetition may include one or more of spatial repetition (e.g., transmitting a NACK using multiple beams), repetition in frequency, or repetition in time.

In some cases, the DCI (or other signaling mechanism) may be used to semi-persistently schedule (SPS) an acknowledgment feedback mode. In other words, the acknowledgment feedback mode indicated via the signaling may be used until subsequent signaling indicating a different acknowledgment feedback mode is received.

If RRC signaling is used to indicate an acknowledgment feedback mode, various RRC messages may be used. For example the network may provide the indication via an RRC Setup message, an RRC Reconfiguration message, an RRC Reestablishment message, or an RRC Resume message.

In some cases, a UE may request a particular acknowledgment feedback mode. For example, a UE might request the NACK only transmission mode during an SPS establishment procedure if the UE battery level is low.

The UE may send such a request via an RRC message with an addition of a HARQ Feedback Type field (e.g., similar to that shown in the example DCI of FIG. 20). The RRC messages used by the UE to send the request may include an RRC Setup Request message, an RRC Reestablishment Request message, an RRC Resume Request message, or a UE Assistance Information message.

As described herein, the ability to signal different acknowledgment feedback modes, as described herein, may provide flexibility to adapt feedback to different types of communication with different needs.

In this case, because the UE does not send NACK to tell the network that PDSCH is not decoded, the network will not send a retransmission based on MAC layer retransmission protocol for the failed DL data. The network may, thus, have to rely on RLC or PDCP layer retransmission for the failed DL data transmission.

In some cases, rather than transmitting a frame a device may have an interface to output a frame for transmission (a means for outputting). For example, a processor may output a frame, via a bus interface, to a radio frequency (RF) front end for transmission. Similarly, rather than receiving a frame, a device may have an interface to obtain a frame received from another device (a means for obtaining). For example, a processor may obtain (or receive) a frame, via a bus interface, from an RF front end for reception.

In some examples, a method of wireless communication includes receiving, by a UE from a BS, a NACK transmission configuration; receiving, by the UE from the BS, a data transmission; and transmitting, by the UE to the BS, a PUCCH signal including a NACK for the data transmission based on the received NACK transmission configuration. In some cases, receiving the NACK transmission configuration may include receiving, by the UE from the BS, a flag indicating whether to increase a transmit power of the PUCCH signal when the PUCCH signal includes the NACK. In some cases, receiving the NACK transmission configuration may include receiving, by the UE from the BS, a transmit power parameter. In some cases, receiving the NACK transmission configuration may include receiving, by the UE from the BS, a plurality of transmit power parameters, where each transmit power parameter of the plurality of transmit power parameters is associated with a logical channel of a plurality of logical channels. In some cases, transmitting the PUCCH signal may include transmitting, by the UE to the BS, the PUCCH signal using a first transmit power parameter of the plurality of transmit power parameters based on a logical channel associated with the data transmission. In some cases, receiving the NACK transmission configuration may include receiving, by the UE from the BS, a plurality of transmit power parameters, where each transmit power parameter of the plurality of transmit power parameters is associated with a PUCCH format of a plurality of PUCCH formats, and where the plurality of PUCCH formats includes at least one of a PUCCH format 0, a PUCCH format 1, a PUCCH format 2, a PUCCH format 3, or a PUCCH format 4. In some cases, transmitting the PUCCH signal may include transmitting, by the UE to the BS, the PUCCH signal using a first transmit power parameter of the plurality of transmit power parameters based on a PUCCH format of the PUCCH signal.

In some cases, receiving the NACK transmission configuration may include receiving, by the UE from the BS, a PUCCH configuration including: a first transmit power offset for a non-NACK transmission; and the NACK transmission configuration including a second transmit power offset different from the first transmit power offset. The second transmit power offset may correspond to a higher transmit power than the first transmit power offset. In some cases, receiving the NACK transmission configuration may include receiving, by the UE from the BS, a PUCCH configuration including: a first target received power for a non-NACK transmission; and the NACK transmission configuration including a second target received power different from the first target received power. The second target received power may be greater than the first target received power. In some cases, receiving the NACK transmission configuration may include receiving, by the UE from the BS, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

In some examples, receiving the NACK transmission configuration may include receiving, by the UE from the BS, a beam parameter indicating a number of transmission beams. In some examples, transmitting the PUCCH signal may include transmitting, by the UE to the BS, a first PUCCH signal including the NACK in a first beam direction; and transmitting, by the UE to the BS based on the beam parameter, a second PUCCH signal including the NACK in a second beam direction different from the first beam direction. The beam parameter may indicate a beam sequence including the first beam direction and the second beam direction. In some cases, transmitting the PUCCH signal may include transmitting, by the UE to the BS, the first PUCCH signal in the first beam direction during a first time period; and transmitting, by the UE to the BS, the second PUCCH signal in the second beam direction during a second time period different from the first time period. In some cases, transmitting the PUCCH signal may include transmitting, by the UE to the BS based on the beam parameter, the second PUCCH signal in the second beam direction simultaneously with the first PUCCH signal in the first beam direction.

In some examples, receiving the NACK transmission configuration may include receiving, by the UE from the BS, a PUCCH configuration including: a first resource allocation for a non-NACK transmission; and the NACK transmission configuration including a second resource allocation different from the first resource allocation. In some examples, transmitting the PUCCH signal may include transmitting, by the UE to the BS, the PUCCH signal including the NACK without other UCI based on the PUCCH signal having a PUCCH format 0 or a PUCCH format 1. In some cases, the method may further include receiving, by the UE from the BS, a SR timer configuration based on the NACK transmission configuration; and transmitting, by the UE, an SR in a next PUCCH occasion based on the SR timer configuration. In some examples, transmitting the PUCCH signal may include transmitting, by the UE to the BS, the PUCCH signal based on a PUCCH format that is not a PUCCH format 2 based on the PUCCH signal including the NACK. In some cases, transmitting the PUCCH signal may include transmitting, by the UE to the BS, an UL communication signal multiplexing the PUCCH signal with UL data based on the UL data being associated with an URLLC. In some cases, transmitting the PUCCH signal may include transmitting, by the UE to the BS, the PUCCH signal including the NACK without multiplexing the PUCCH signal with UL data based on the UL data being associated with a non-URLLC. In some cases, transmitting the PUCCH signal may include transmitting, by the UE to the BS, the PUCCH signal based on a transmit power increment, where the method further includes receiving, by the UE from the BS, a transmit power control command after transmitting the PUCCH signal; and transmitting, by the UE to the BS, a second PUCCH signal based on the transmit power control command and the transmit power increment.

In some examples, a method of wireless communication may include: transmitting, by a BS to a UE, a NACK transmission configuration; transmitting, by the BS to the UE, a data transmission; and receiving, by the BS from the UE, a PUCCH signal including a NACK for the data transmission based on the received NACK transmission configuration. In some cases, transmitting the NACK transmission configuration may include transmitting, by the BS to the UE, a flag indicating whether to increase a transmit power of the PUCCH signal when the PUCCH signal includes the NACK. In some cases, transmitting the NACK transmission configuration may include transmitting, by the BS to the UE, a transmit power parameter. In some cases, transmitting the NACK transmission configuration may include transmitting, by the BS to the UE, a plurality of transmit power parameters, wherein each transmit power parameter of the plurality of transmit power parameters is associated with a logical channel of a plurality of logical channels. In some cases, receiving the PUCCH signal may include receiving, by the BS from the UE, the PUCCH signal using a first transmit power parameter of the plurality of transmit power parameters based on a logical channel associated with the data transmission.

In some cases, transmitting the NACK transmission configuration may include transmitting, by the BS to the UE, a plurality of transmit power parameters, where each transmit power parameter of the plurality of transmit power parameters is associated with a PUCCH format of a plurality of PUCCH formats, and where the plurality of PUCCH formats include at least one of a PUCCH format 0, a PUCCH format 1, a PUCCH format 2, a PUCCH format 3, or a PUCCH format 4. In some cases, transmitting the NACK transmission configuration may include transmitting, by the BS to the UE, a PUCCH configuration including: a first transmit power offset for a non-NACK transmission; and the NACK transmission configuration including a second transmit power offset different from the first transmit power offset. The second transmit power offset may correspond to a higher transmit power than the first transmit power offset.

In some cases, transmitting the NACK transmission configuration may include transmitting, by the BS to the UE, a PUCCH configuration including: a first target received power for a non-NACK transmission; and the NACK transmission configuration including a second target received power different from the first target received power. The second target received power may be greater than the first target received power. In some cases, transmitting the NACK transmission configuration may include transmitting, by the BS to the UE, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

In some examples, transmitting the NACK transmission configuration may include transmitting, by the BS to the UE, a beam parameter indicating a number of transmission beams. In some cases, receiving the PUCCH signal may include receiving, by the BS from the UE based on the beam parameter, a first PUCCH signal including the NACK in a first beam direction; and receiving, by the BS from the UE based on the beam parameter, a second PUCCH signal including the NACK in a second beam direction different from the first beam direction. The beam parameter may indicate a beam sequence including the first beam direction and the second beam direction. In some cases, receiving the PUCCH signal may include: receiving, by the BS from the UE, the first PUCCH signal in the first beam direction during a first time period; and receiving, by the BS from the UE, the second PUCCH signal in the second beam direction during a second time period different from the first time period. In some cases, receiving the PUCCH signal may include receiving, by the BS from the UE based on the beam parameter, the second PUCCH signal in the second beam direction simultaneously with the first PUCCH signal in the first beam direction. In some cases, transmitting the NACK transmission configuration may include transmitting, by the BS to the UE, a PUCCH configuration including: a first resource allocation for a non-NACK transmission; and the NACK transmission configuration including a second resource allocation different from the first resource allocation. The method may further include monitoring, by the BS, for an ACK/NACK for the data transmission based on the first resource allocation and the second resource allocation, wherein the monitoring includes receiving the PUCCH signal based on the second resource allocation.

In some examples, receiving the PUCCH signal may include receiving, by the BS from the UE, the PUCCH signal including the NACK without other UCI based on the PUCCH signal having a PUCCH format 0 or a PUCCH format 1. The method may further include: transmitting, by the BS to the UE, a SR timer configuration based on the NACK transmission configuration; and receiving, by the UE, an SR in a next PUCCH occasion based on the SR timer configuration. In some examples, receiving the PUCCH signal may include receiving, by the BS from the UE, the PUCCH signal based on a PUCCH format that is not a PUCCH format 2 based on the PUCCH signal including the NACK. In some examples, receiving the PUCCH signal may include receiving, by the BS from the UE, an UL communication signal multiplexing the PUCCH signal with UL data based on the UL data being associated with an URLLC. In some examples, receiving the PUCCH signal may include receiving, by the BS from the UE, the PUCCH signal including the NACK without multiplexing the PUCCH signal with UL data based on the UL data being associated with a non-URLLC. In some cases, receiving the PUCCH signal may include receiving, by the BS from the UE, the PUCCH signal based on a transmit power increment, where the method further includes transmitting, by the BS to the UE, a transmit power control command based on the transmit power increment.

In some examples, a UE includes a processor and a transceiver coupled to the processor, where the transceiver is configured to: receive, from a BS, a NACK transmission configuration; receive, from the BS, a data transmission; and transmit, to the BS, a PUCCH signal including a NACK for the data transmission based on the received NACK transmission configuration. In some cases, the transceiver that is configured to receive the NACK transmission configuration may be configured to receive, from the BS, a flag indicating whether to increase a transmit power of the PUCCH signal when the PUCCH signal includes the NACK. In some cases, the transceiver that is configured to receive the NACK transmission configuration may be configured to receive, from the BS, a transmit power parameter. In some cases, the transceiver that is configured to receive the NACK transmission configuration may be configured to receive, from the BS, a plurality of transmit power parameters, wherein each transmit power parameter of the plurality of transmit power parameters is associated with a logical channel of a plurality of logical channels. In some cases, the transceiver that is configured to transmit the PUCCH signal is configured to transmit, to the BS, the PUCCH signal using a first transmit power parameter of the plurality of transmit power parameters based on a logical channel associated with the data transmission.

In some examples, the transceiver that is configured to receive the NACK transmission configuration may be configured to receive, from the BS, a plurality of transmit power parameters, where each transmit power parameter of the plurality of transmit power parameters is associated with a PUCCH format of a plurality of PUCCH formats, and where the plurality of PUCCH formats include at least one of a PUCCH format 0, a PUCCH format 1, a PUCCH format 2, a PUCCH format 3, or a PUCCH format 4. In some cases, the transceiver that is configured to transmit the PUCCH signal is further configured to transmit, to the BS, the PUCCH signal using a first transmit power parameter of the plurality of transmit power parameters based on a PUCCH format of the PUCCH signal. In some cases, the transceiver that is configured to receive the NACK transmission configuration may be configured to receive, from the BS, a PUCCH configuration including: a first transmit power offset for a non-NACK transmission; and the NACK transmission configuration including a second transmit power offset different from the first transmit power offset. The second transmit power offset may correspond to a higher transmit power than the first transmit power offset. In some cases, the transceiver that is configured to receive the NACK transmission configuration may be configured to receive, from the BS, a PUCCH configuration including: a first target received power for a non-NACK transmission; and the NACK transmission configuration including a second target received power different from the first target received power. The second target received power may be greater than the first target received power. In some cases, the transceiver that is configured to receive the NACK transmission configuration may be configured to receive, from the BS, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

In some examples, the transceiver that is configured to receive the NACK transmission configuration may be configured to receive, from the BS, a beam parameter indicating a number of transmission beams. In some cases, the transceiver that is configured to transmit the PUCCH signal may be configured to: transmit, to the BS, a first PUCCH signal including the NACK in a first beam direction; and transmit, to the BS based on the beam parameter, a second PUCCH signal including the NACK in a second beam direction different from the first beam direction. In some cases, the beam parameter may indicate a beam sequence including the first beam direction and the second beam direction. In some examples, the transceiver that is configured to transmit the PUCCH signal may be configured to: transmit, to the BS, the first PUCCH signal in the first beam direction during a first time period; and transmit, to the BS, the second PUCCH signal in the second beam direction during a second time period different from the first time period. In some cases, the transceiver that is configured to transmit the PUCCH signal may be configured to transmit, to the BS based on the beam parameter, the second PUCCH signal in the second beam direction simultaneously with the first PUCCH signal in the first beam direction.

In some examples, the transceiver that is configured to receive the NACK transmission configuration may be configured to: receive, from the BS, a PUCCH configuration including: a first resource allocation for a non-NACK transmission; and the NACK transmission configuration including a second resource allocation different from the first resource allocation. In some cases, the transceiver that is configured to transmit the PUCCH signal may be configured to transmit, to the BS, the PUCCH signal including the NACK without other UCI based on the PUCCH signal having a PUCCH format 0 or a PUCCH format 1.

In some examples, the transceiver is further configured to: receive, from the BS, a scheduling request (SR) timer configuration based on the NACK transmission configuration; and transmit, by the UE, an SR in a next PUCCH occasion based on the SR timer configuration. In some cases, the transceiver that is configured to transmit the PUCCH signal may be configured to transmit, to the BS, the PUCCH signal based on a PUCCH format that is not a PUCCH format 2 based on the PUCCH signal including the NACK. In some cases, the transceiver that is configured to transmit the PUCCH signal may be configured to transmit, to the BS, an UL communication signal multiplexing the PUCCH signal with UL data based on the UL data being associated with an URLLC. In some cases, the transceiver that is configured to transmit the PUCCH signal may be configured to transmit, to the BS, the PUCCH signal including the NACK without multiplexing the PUCCH signal with UL data based on the UL data being associated with a non-URLLC.

In some examples, the transceiver that is configured to transmit the PUCCH signal may be configured to transmit, to the BS, the PUCCH signal based on a transmit power increment, where the transceiver may be further configured to: receive, from the BS, a transmit power control command after transmitting the PUCCH signal; and transmit, to the BS, a second PUCCH signal based on the transmit power control command and the transmit power increment.

In some examples, a BS may include a processor and a transceiver coupled to the processor, where the transceiver is configured to: transmit, to a UE, a NACK transmission configuration; transmit, to the UE, a data transmission; and receive, from the UE, a PUCCH signal including a NACK for the data transmission based on the received NACK transmission configuration. In some cases, the transceiver that is configured to transmit the NACK transmission configuration may be configured to transmit, to the UE, a flag indicating whether to increase a transmit power of the PUCCH signal when the PUCCH signal includes the NACK. In some cases, the transceiver that is configured to transmit the NACK transmission configuration may be configured to transmit, to the UE, a transmit power parameter. In some cases, the transceiver that is configured to transmit the NACK transmission configuration may be configured to transmit, to the UE, a plurality of transmit power parameters, where each transmit power parameter of the plurality of transmit power parameters is associated with a logical channel of a plurality of logical channels. In some cases, the transceiver that is configured to receive the PUCCH signal may be configured to receive, from the UE, the PUCCH signal using a first transmit power parameter of the plurality of transmit power parameters based on a logical channel associated with the data transmission.

In some examples, the transceiver that is configured to transmit the NACK transmission configuration may be configured to transmit, to the UE, a plurality of transmit power parameters, where each transmit power parameter of the plurality of transmit power parameters is associated with a PUCCH format of a plurality of PUCCH formats, and where the plurality of PUCCH formats include at least one of a PUCCH format 0, a PUCCH format 1, a PUCCH format 2, a PUCCH format 3, or a PUCCH format 4. In some cases, the transceiver that is configured to transmit the NACK transmission configuration may be configured to transmit, to the UE, a PUCCH configuration including: a first transmit power offset for a non-NACK transmission; and the NACK transmission configuration including a second transmit power offset different from the first transmit power offset. The second transmit power offset may correspond to a higher transmit power than the first transmit power offset.

In some cases, the transceiver that is configured to transmit the NACK transmission configuration may be configured to transmit, to the UE, a PUCCH configuration including: a first target received power for a non-NACK transmission; and the NACK transmission configuration including a second target received power different from the first target received power. The second target received power may be greater than the first target received power. In some cases, the transceiver that is configured to transmit the NACK transmission configuration may be configured to transmit, to the UE, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

In some examples, the transceiver that is configured to transmit the NACK transmission configuration may be configured to transmit, to the UE, a beam parameter indicating a number of transmission beams. In some examples, the transceiver that is configured to receive the PUCCH signal may be configured to: receive, from the UE based on the beam parameter, a first PUCCH signal including the NACK in a first beam direction; and receive, from the UE based on the beam parameter, a second PUCCH signal including the NACK in a second beam direction different from the first beam direction. In some cases, the beam parameter may indicate a beam sequence including the first beam direction and the second beam direction. In some cases, the transceiver that is configured to receive the PUCCH signal may be configured to: receive, from the UE, the first PUCCH signal in the first beam direction during a first time period; and receive, from the UE, the second PUCCH signal in the second beam direction during a second time period different from the first time period. In some cases, the transceiver that is configured to receive the PUCCH signal may be configured to receive, from the UE based on the beam parameter, the second PUCCH signal in the second beam direction simultaneously with the first PUCCH signal in the first beam direction.

In some examples, the transceiver that is configured to transmit the NACK transmission configuration may be configured to transmit, to the UE, a PUCCH configuration including: a first resource allocation for a non-NACK transmission; and the NACK transmission configuration including a second resource allocation different from the first resource allocation. In some cases, the processor that is coupled to the transceiver may be configured to monitor for an ACK/NACK for the data transmission based on the first resource allocation and the second resource allocation, where the PUCCH signal is received from the monitoring. In some cases, the transceiver that is configured to receive the PUCCH signal may be configured to receive, from the UE, the PUCCH signal including the NACK without other UCI based on the PUCCH signal having a PUCCH format 0 or a PUCCH format 1. In some cases, the transceiver that is coupled to the processor may be configured to: transmit, to the UE, a SR timer configuration based on the NACK transmission configuration; and receive an SR in a next PUCCH occasion based on the SR timer configuration.

In some examples, the transceiver that is configured to receive the PUCCH signal may be configured to receive, from the UE, the PUCCH signal based on a PUCCH format that is not a PUCCH format 2 based on the PUCCH signal including the NACK. In some cases, the transceiver that is configured to receive the PUCCH signal may be configured to receive, from the UE, an UL communication signal multiplexing the PUCCH signal with UL data based on the UL data being associated with an URLLC. In some cases, the transceiver that is configured to receive the PUCCH signal may be configured to receive, from the UE, the PUCCH signal including the NACK without multiplexing the PUCCH signal with UL data based on the UL data being associated with a non-URLLC. In some cases, the transceiver that is configured to receive the PUCCH signal may be configured to receive, from the UE, the PUCCH signal based on a transmit power increment, where the transceiver may be further configured to transmit, to the UE, a transmit power control command based on the transmit power increment.

In some examples, a non-transitory computer-readable medium having program code recorded thereon, the program code including: code for causing a UE to receive, from a BS, a NACK transmission configuration; code for causing the UE to receive, from the BS, a data transmission; and code for causing the UE to transmit, to the BS, a PUCCH signal including a NACK for the data transmission based on the received NACK transmission configuration. In some cases, the code for causing the UE to receive the NACK transmission configuration may be configured to receive, from the BS, a flag indicating whether to increase a transmit power of the PUCCH signal when the PUCCH signal includes the NACK.

In some cases, the code for causing the UE to receive the NACK transmission configuration may be configured to receive, from the BS, a transmit power parameter. In some cases, the code for causing the UE to receive the NACK transmission configuration may be configured to receive, from the BS, a plurality of transmit power parameters, wherein each transmit power parameter of the plurality of transmit power parameters is associated with a logical channel of a plurality of logical channels. In some cases, the code for causing the UE to transmit the PUCCH signal may be configured to transmit, to the BS, the PUCCH signal using a first transmit power parameter of the plurality of transmit power parameters based on a logical channel associated with the data transmission. In some cases, the code for causing the UE to receive the NACK transmission configuration may be configured to receive, from the BS, a plurality of transmit power parameters, where each transmit power parameter of the plurality of transmit power parameters is associated with a PUCCH format of a plurality of PUCCH formats, and where the plurality of PUCCH formats include at least one of a PUCCH format 0, a PUCCH format 1, a PUCCH format 2, a PUCCH format 3, or a PUCCH format 4. In some cases, the code for causing the UE to transmit the PUCCH signal may be configured to transmit, to the BS, the PUCCH signal using a first transmit power parameter of the plurality of transmit power parameters based on a PUCCH format of the PUCCH signal.

In some examples, the code for causing the UE to receive the NACK transmission configuration may be configured to receive, from the BS, a PUCCH configuration including: a first transmit power offset for a non-NACK transmission; and the NACK transmission configuration including a second transmit power offset different from the first transmit power offset. In some cases, the second transmit power offset may correspond to a higher transmit power than the first transmit power offset. In some examples, the code for causing the UE to receive the NACK transmission configuration may be configured to receive, from the BS, a PUCCH configuration including: a first target received power for a non-NACK transmission; and the NACK transmission configuration including a second target received power different from the first target received power. The second target received power may be greater than the first target received power. In some cases, the code for causing the UE to receive the NACK transmission configuration may be configured to receive, from the BS, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

In some examples, the code for causing the UE to receive the NACK transmission configuration may be configured to receive, from the BS, a beam parameter indicating a number of transmission beams. In some cases, the code for causing the UE to transmit the PUCCH signal may be configured to: transmit, to the BS, a first PUCCH signal including the NACK in a first beam direction; and transmit, to the BS based on the beam parameter, a second PUCCH signal including the NACK in a second beam direction different from the first beam direction. In some cases, the beam parameter may further indicate a beam sequence including the first beam direction and the second beam direction. In some cases, the code for causing the UE to transmit the PUCCH signal may be configured to: transmit, to the BS, the first PUCCH signal in the first beam direction during a first time period; and transmit, to the BS, the second PUCCH signal in the second beam direction during a second time period different from the first time period. In some cases, the code for causing the UE to transmit the PUCCH signal may be configured to transmit, to the BS based on the beam parameter, the second PUCCH signal in the second beam direction simultaneously with the first PUCCH signal in the first beam direction. In some cases, the code for causing the UE to receive the NACK transmission configuration may be configured to receive, from the BS, a PUCCH configuration including: a first resource allocation for a non-NACK transmission; and the NACK transmission configuration including a second resource allocation different from the first resource allocation.

In some examples, the code for causing the UE to transmit the PUCCH signal may be configured to transmit, to the BS, the PUCCH signal including the NACK without other UCI based on the PUCCH signal having a PUCCH format 0 or a PUCCH format 1. In some examples, the non-transitory computer-readable medium may further include: code for causing the UE to receive, from the BS, a SR timer configuration based on the NACK transmission configuration; and code for causing the UE to transmit, by the UE, an SR in a next PUCCH occasion based on the SR timer configuration. In some cases, the code for causing the UE to transmit the PUCCH signal may be configured to transmit, to the BS, the PUCCH signal based on a PUCCH format that is not a PUCCH format 2 based on the PUCCH signal including the NACK. In some cases, the code for causing the UE to transmit the PUCCH signal may be configured to transmit, to the BS, an UL communication signal multiplexing the PUCCH signal with UL data based on the UL data being associated with an URLLC. In some cases, the code for causing the UE to transmit the PUCCH signal may be configured to transmit, to the BS, the PUCCH signal including the NACK without multiplexing the PUCCH signal with UL data based on the UL data being associated with a non-URLLC.

In some examples, the code for causing the UE to transmit the PUCCH signal may further include code for causing the UE to transmit, to the BS, the PUCCH signal based on a transmit power increment, where the program code further includes: code for causing the UE to receive, from the BS, a transmit power control command after transmitting the PUCCH signal; and code for causing the UE to transmit, to the BS, a second PUCCH signal based on the transmit power control command and the transmit power increment.

In some examples, a non-transitory computer-readable medium having program code recorded thereon, the program code including: code for causing a BS to transmit, to a UE, a NACK transmission configuration; code for causing the BS to transmit, to the UE, a data transmission; and code for causing the BS to receive, from the UE, a PUCCH signal including a NACK for the data transmission based on the received NACK transmission configuration. In some cases, the code for causing the BS to transmit the NACK transmission configuration may be configured to transmit, to the UE, a flag indicating whether to increase a transmit power of the PUCCH signal when the PUCCH signal includes the NACK. In some cases, the code for causing the BS to transmit the NACK transmission configuration may be configured to transmit, to the UE, a transmit power parameter. In some cases, the code for causing the BS to transmit the NACK transmission configuration may be configured to transmit, to the UE, a plurality of transmit power parameters, where each transmit power parameter of the plurality of transmit power parameters is associated with a logical channel of a plurality of logical channels. In some cases, the code for causing the BS to receive the PUCCH signal may be configured to receive, from the UE, the PUCCH signal using a first transmit power parameter of the plurality of transmit power parameters based on a logical channel associated with the data transmission.

In some examples, the code for causing the BS to transmit the NACK transmission configuration may be configured to transmit, to the UE, a plurality of transmit power parameters, where each transmit power parameter of the plurality of transmit power parameters is associated with a PUCCH format of a plurality of PUCCH formats, wherein the plurality of PUCCH formats include at least one of a PUCCH format 0, a PUCCH format 1, a PUCCH format 2, a PUCCH format 3, or a PUCCH format 4. In some cases, the code for causing the BS to transmit the NACK transmission configuration may be configured to transmit, to the UE, a PUCCH configuration including: a first transmit power offset for a non-NACK transmission; and the NACK transmission configuration including a second transmit power offset different from the first transmit power offset. The second transmit power offset may correspond to a higher transmit power than the first transmit power offset.

In some examples, the code for causing the BS to transmit the NACK transmission configuration may be configured to transmit, to the UE, a PUCCH configuration including: a first target received power for a non-NACK transmission; and the NACK transmission configuration including a second target received power different from the first target received power. The second target received power may be greater than the first target received power. In some cases, the code for causing the BS to transmit the NACK transmission configuration may be configured to transmit, to the UE, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

In some examples, the code for causing the BS to transmit the NACK transmission configuration may be configured to transmit, to the UE, a beam parameter indicating a number of transmission beams. In some cases, the code for causing the BS to receive the PUCCH signal may be configured to: receive, from the UE based on the beam parameter, a first PUCCH signal including the NACK in a first beam direction; and receive, from the UE based on the beam parameter, a second PUCCH signal including the NACK in a second beam direction different from the first beam direction. The beam parameter may further indicate a beam sequence including the first beam direction and the second beam direction.

In some cases, the code for causing the BS to receive the PUCCH signal may be configured to: receive, from the UE, the first PUCCH signal in the first beam direction during a first time period; and receive, from the UE, the second PUCCH signal in the second beam direction during a second time period different from the first time period. In some cases, the code for causing the BS to receive the PUCCH signal may be configured to receive, from the UE based on the beam parameter, the second PUCCH signal in the second beam direction simultaneously with the first PUCCH signal in the first beam direction. In some examples, the code for causing the BS to transmit the NACK transmission configuration may be configured to transmit, to the UE, a PUCCH configuration including: a first resource allocation for a non-NACK transmission; and the NACK transmission configuration including a second resource allocation different from the first resource allocation. In some cases, the non-transitory computer-readable medium includes code for causing the BS to monitor for an ACK/NACK for the data transmission based on the first resource allocation and the second resource allocation, where the PUCCH signal is received from the monitoring.

In some examples, the code for causing the BS to receive the PUCCH signal may be configured to receive, from the UE, the PUCCH signal including the NACK without other UCI based on the PUCCH signal having a PUCCH format 0 or a PUCCH format 1. In some cases, the non-transitory computer-readable medium includes: code for causing the BS to transmit, to the UE, a SR timer configuration based on the NACK transmission configuration; and code for causing the BS to receive an SR in a next PUCCH occasion based on the SR timer configuration. In some cases, the code for causing the BS to receive the PUCCH signal may be configured to receive, from the UE, the PUCCH signal based on a PUCCH format that is not a PUCCH format 2 based on the PUCCH signal including the NACK. In some cases, the code for causing the BS to receive the PUCCH signal may be configured to receive, from the UE, an UL communication signal multiplexing the PUCCH signal with UL data based on the UL data being associated with an URLLC. In some cases, the code for causing the BS to receive the PUCCH signal may be configured to receive, from the UE, the PUCCH signal including the NACK without multiplexing the PUCCH signal with UL data based on the UL data being associated with a non-URLLC. In some cases, the code for causing the BS to receive the PUCCH signal may include: code for causing the BS to receive, from the UE, the PUCCH signal based on a transmit power increment, where the program code further includes code for causing the BS to transmit, to the UE, a transmit power control command based on the transmit power increment.

In some examples, a UE includes: means for receiving, from a BS, a NACK transmission configuration; means for receiving, from the BS, a data transmission; and means for transmitting, to the BS, a PUCCH signal including a NACK for the data transmission based on the received NACK transmission configuration. In some cases, the means for receiving the NACK transmission configuration may be configured to receive, from the BS, a flag indicating whether to increase a transmit power of the PUCCH signal when the PUCCH signal includes the NACK. In some cases, the means for receiving the NACK transmission configuration may be configured to receive, from the BS, a transmit power parameter. In some cases, the means for receiving the NACK transmission configuration may be configured to receive, from the BS, a plurality of transmit power parameters, where each transmit power parameter of the plurality of transmit power parameters is associated with a logical channel of a plurality of logical channels. In some cases, the means for transmitting the PUCCH signal may be configured to transmit, to the BS, the PUCCH signal using a first transmit power parameter of the plurality of transmit power parameters based on a logical channel associated with the data transmission.

In some examples, the means for receiving the NACK transmission configuration may be configured to receive, from the BS, a plurality of transmit power parameters, where each transmit power parameter of the plurality of transmit power parameters is associated with a PUCCH format of a plurality of PUCCH formats, and where the plurality of PUCCH formats include at least one of a PUCCH format 0, a PUCCH format 1, a PUCCH format 2, a PUCCH format 3, or a PUCCH format 4. In some cases, the means for transmitting the PUCCH signal may be further configured to transmit, to the BS, the PUCCH signal using a first transmit power parameter of the plurality of transmit power parameters based on a PUCCH format of the PUCCH signal. In some cases, the means for receiving the NACK transmission configuration may be configured to receive, from the BS, a PUCCH configuration including: a first transmit power offset for a non-NACK transmission; and the NACK transmission configuration including a second transmit power offset different from the first transmit power offset. The second transmit power offset may correspond to a higher transmit power than the first transmit power offset.

In some examples, the means for receiving the NACK transmission configuration may be configured to receive, from the BS, a PUCCH configuration including: a first target received power for a non-NACK transmission; and the NACK transmission configuration including a second target received power different from the first target received power. The second target received power may be greater than the first target received power. In some cases, the means for receiving the NACK transmission configuration may be configured to receive, from the BS, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

In some examples, the means for receiving the NACK transmission configuration may be configured to receive, from the BS, a beam parameter indicating a number of transmission beams. In some cases, the means for transmitting the PUCCH signal may be configured to: transmit, to the BS, a first PUCCH signal including the NACK in a first beam direction; and transmit, to the BS based on the beam parameter, a second PUCCH signal including the NACK in a second beam direction different from the first beam direction. The beam parameter may further indicate a beam sequence including the first beam direction and the second beam direction. In some cases, the means for transmitting the PUCCH signal may be configured to: transmit, to the BS, the first PUCCH signal in the first beam direction during a first time period; and transmit, to the BS, the second PUCCH signal in the second beam direction during a second time period different from the first time period. In some cases, the means for transmitting the PUCCH signal may be configured to transmit, to the BS based on the beam parameter, the second PUCCH signal in the second beam direction simultaneously with the first PUCCH signal in the first beam direction. In some cases, the means for receiving the NACK transmission configuration may be configured to receive, from the BS, a PUCCH configuration including: a first resource allocation for a non-NACK transmission; and the NACK transmission configuration including a second resource allocation different from the first resource allocation.

In some examples, the means for transmitting the PUCCH signal may be configured to transmit, to the BS, the PUCCH signal including the NACK without other UCI based on the PUCCH signal having a PUCCH format 0 or a PUCCH format 1. In some cases, the UE may further include: means for receiving, from the BS, a SR timer configuration based on the NACK transmission configuration; and means for transmitting, by the UE, an SR in a next PUCCH occasion based on the SR timer configuration. In some cases, the means for transmitting the PUCCH signal may be configured to transmit, to the BS, the PUCCH signal based on a PUCCH format that is not a PUCCH format 2 based on the PUCCH signal including the NACK. In some cases, the means for transmitting the PUCCH signal may be configured to transmit, to the BS, an UL communication signal multiplexing the PUCCH signal with UL data based on the UL data being associated with an URLLC. In some cases, the means for transmitting the PUCCH signal may be configured to transmit, to the BS, the PUCCH signal including the NACK without multiplexing the PUCCH signal with UL data based on the UL data being associated with a non-URLLC.

In some examples, the means for transmitting the PUCCH signal includes means for transmitting, to the BS, the PUCCH signal based on a transmit power increment, and where the UE further includes: means for receiving, from the BS, a transmit power control command after transmitting the PUCCH signal; and means for transmitting, to the BS, a second PUCCH signal based on the transmit power control command and the transmit power increment.

In some examples, a BS includes: means for transmitting, to a UE, a NACK transmission configuration; means for transmitting, to the UE, a data transmission; and means for receiving, from the UE, a PUCCH signal including a NACK for the data transmission based on the received NACK transmission configuration. In some cases, the means for transmitting the NACK transmission configuration may be configured to transmit, to the UE, a flag indicating whether to increase a transmit power of the PUCCH signal when the PUCCH signal includes the NACK. In some cases, the means for transmitting the NACK transmission configuration may be configured to transmit, to the UE, a transmit power parameter. In some cases, the means for transmitting the NACK transmission configuration may be configured to transmit, to the UE, a plurality of transmit power parameters, where each transmit power parameter of the plurality of transmit power parameters is associated with a logical channel of a plurality of logical channels. In some cases, the means for receiving the PUCCH signal may be configured to receive, from the UE, the PUCCH signal using a first transmit power parameter of the plurality of transmit power parameters based on a logical channel associated with the data transmission.

In some examples, the means for transmitting the NACK transmission configuration may be configured to transmit, to the UE, a plurality of transmit power parameters, where each transmit power parameter of the plurality of transmit power parameters is associated with a PUCCH format of a plurality of PUCCH formats, and where the plurality of PUCCH formats include at least one of a PUCCH format 0, a PUCCH format 1, a PUCCH format 2, a PUCCH format 3, or a PUCCH format 4. In some cases, the means for transmitting the NACK transmission configuration may be configured to transmit, to the UE, a PUCCH configuration including: a first transmit power offset for a non-NACK transmission; and the NACK transmission configuration including a second transmit power offset different from the first transmit power offset. The second transmit power offset may correspond to a higher transmit power than the first transmit power offset.

In some examples, the means for transmitting the NACK transmission configuration may be configured to transmit, to the UE, a PUCCH configuration including: a first target received power for a non-NACK transmission; and the NACK transmission configuration including a second target received power different from the first target received power. The second target received power may be greater than the first target received power. In some cases, the means for transmitting the NACK transmission configuration may be configured to transmit, to the UE, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

In some examples, the means for transmitting the NACK transmission configuration may be configured to transmit, to the UE, a beam parameter indicating a number of transmission beams. In some cases, the means for receiving the PUCCH signal may be configured to: receive, from the UE based on the beam parameter, a first PUCCH signal including the NACK in a first beam direction; and receive, from the UE based on the beam parameter, a second PUCCH signal including the NACK in a second beam direction different from the first beam direction. The beam parameter may further indicate a beam sequence including the first beam direction and the second beam direction. In some cases, the means for receiving the PUCCH signal may be configured to: receive, from the UE, the first PUCCH signal in the first beam direction during a first time period; and receive, from the UE, the second PUCCH signal in the second beam direction during a second time period different from the first time period. In some cases, the means for receiving the PUCCH signal may be configured to: receive, from the UE based on the beam parameter, the second PUCCH signal in the second beam direction simultaneously with the first PUCCH signal in the first beam direction. In some cases, the means for transmitting the NACK transmission configuration may be configured to transmit, to the UE, a PUCCH configuration including: a first resource allocation for a non-NACK transmission; and the NACK transmission configuration including a second resource allocation different from the first resource allocation.

In some examples, the BS may further include means for monitoring for an ACK/NACK for the data transmission based on the first resource allocation and the second resource allocation, wherein the PUCCH signal is received from the monitoring. In some cases, the means for receiving the PUCCH signal may be configured to receive, from the UE, the PUCCH signal including the NACK without other UCI based on the PUCCH signal having a PUCCH format 0 or a PUCCH format 1. In some examples, the BS may further include: means for transmitting, to the UE, a SR timer configuration based on the NACK transmission configuration; and means for receiving an SR in a next PUCCH occasion based on the SR timer configuration. In some cases, the means for receiving the PUCCH signal may be configured to receive, from the UE, the PUCCH signal based on a PUCCH format that is not a PUCCH format 2 based on the PUCCH signal including the NACK. In some cases, the means for receiving the PUCCH signal may be configured to receive, from the UE, an UL communication signal multiplexing the PUCCH signal with UL data based on the UL data being associated with an URLLC. In some cases, the means for receiving the PUCCH signal may be configured to receive, from the UE, the PUCCH signal including the NACK without multiplexing the PUCCH signal with UL data based on the UL data being associated with a non-URLLC. In some cases, the means for receiving the PUCCH signal may include means for receiving, from the UE, the PUCCH signal based on a transmit power increment, and the BS may further include means for transmitting, to the UE, a transmit power control command based on the transmit power increment.

In some examples, a method for wireless communications by a UE includes: obtaining signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and communicating with the network entity in accordance with the indicated acknowledgment feedback mode. In some cases, the acknowledgment feedback mode includes a semi-persistently scheduled (SPS) acknowledgment feedback mode. In some cases, the acknowledgment feedback mode includes: a first acknowledgment feedback mode in which the NACK feedback and the ACK feedback are transmitted, wherein the NACK feedback is transmitted with the mechanism to increase reliability relative to the ACK feedback; or a second acknowledgment feedback mode in which only the NACK feedback is transmitted with the mechanism.

In some examples, the mechanism to increase reliability includes at least one of: increased transmission power; the use of at least one of different time resources or frequency resources; transmitting the NACK feedback with repetition; or transmitting the NACK feedback on an uplink channel without multiplexing other signals therein. In some cases, the repetition includes at least one of: repetition in space using multiple beams, repetition in frequency, or repetition in time. In some cases, the communication with the network entity in accordance with the acknowledgment feedback mode includes generating the NACK feedback for transmission to the network entity; or monitoring for the NACK feedback transmitted from the network entity in accordance with the acknowledgment feedback mode. In some cases, the signaling includes a DCI with a field indicating the acknowledgment feedback mode. The DCI may schedule an uplink transmission or schedule a downlink transmission. In some cases, the signaling includes a medium access control (MAC) control element (CE) or radio resource control (RRC) message. In some cases, the RRC message may include: a RRC setup message, a RRC reconfiguration message, a RRC reestablishment message, or a RRC resume message. In some examples, the method for wireless communications by the UE further includes outputting, for transmission to the network entity, a request for the acknowledgment feedback mode, where the signaling is obtained after outputting the request.

In some examples, a method for wireless communications by a network entity includes: outputting, for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and communicating with the UE in accordance with the indicated acknowledgment feedback mode. In some cases, the acknowledgment feedback mode includes a semi-persistently scheduled (SPS) acknowledgment feedback mode. In some cases, the acknowledgment feedback mode includes: a first acknowledgment feedback mode in which the NACK feedback and the ACK feedback are transmitted, where the NACK feedback is transmitted with the mechanism to increase reliability relative to the ACK feedback; or a second acknowledgment feedback mode in which only the NACK feedback is transmitted with the mechanism.

In some examples, the mechanism to increase reliability includes at least one of: increased transmission power; the use of at least one of different time resources or frequency resources; transmitting the NACK feedback with repetition; or transmitting the NACK feedback on an uplink channel without multiplexing other signals. In some cases, the repetition includes at least one of: repetition in space using multiple beams, repetition in frequency, or repetition in time. In some cases, the communication with the UE in accordance with the acknowledgment feedback mode includes: generating the NACK feedback for transmission to the UE; or monitoring for the NACK feedback transmitted from the UE in accordance with the acknowledgment feedback mode.

In some examples, the signaling includes a DCI with a field indicating the acknowledgment feedback mode. In some cases, the DCI may schedule an uplink transmission or schedule a downlink transmission. In some examples, the signaling includes a medium access control (MAC) control element (CE) or radio resource control (RRC) message. In some cases, the RRC message includes: a RRC setup message, a RRC reconfiguration message, a RRC reestablishment message, or a RRC resume message. In some cases, the method for wireless communications by the network entity includes obtaining, from the UE, a request for the acknowledgment feedback mode, wherein the signaling is outputted after obtaining the request.

In some examples, an apparatus for wireless communications by a UE includes: means for obtaining signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and means for communicating with the network entity in accordance with the indicated acknowledgment feedback mode. In some cases, the acknowledgment feedback mode includes a semi-persistently scheduled (SPS) acknowledgment feedback mode. In some cases, the acknowledgment feedback mode includes: a first acknowledgment feedback mode in which the NACK feedback and the ACK feedback are transmitted, wherein the NACK feedback is transmitted with the mechanism to increase reliability relative to the ACK feedback; or a second acknowledgment feedback mode in which only the NACK feedback is transmitted with the mechanism. In some cases, the mechanism to increase reliability includes at least one of: increased transmission power; the use of at least one of different time resources or frequency resources; transmitting the NACK feedback with repetition; or transmitting the NACK feedback on an uplink channel without multiplexing other signals therein. In some cases, the repetition includes at least one of: repetition in space using multiple beams, repetition in frequency, or repetition in time. In some cases, the means for communicating with the network entity in accordance with the acknowledgment feedback mode includes: means for generating the NACK feedback for transmission to the network entity; or means for monitoring for the NACK feedback transmitted from the network entity in accordance with the acknowledgment feedback mode. In some cases, the signaling includes a DCI with a field indicating the acknowledgment feedback mode. In some cases, the DCI may schedule an uplink transmission or schedule a downlink transmission. In some cases, the signaling includes a medium access control (MAC) control element (CE) or radio resource control (RRC) message. In some cases, the RRC message includes a: a RRC setup message, a RRC reconfiguration message, a RRC reestablishment message, or a RRC resume message. In some cases, the apparatus for wireless communications by the UE includes means for outputting, for transmission to the network entity, a request for the acknowledgment feedback mode, wherein the signaling is obtained after outputting the request.

In some examples, an apparatus for wireless communications by a network entity includes: means for outputting, for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and means for communicating with the UE in accordance with the indicated acknowledgment feedback mode. In some cases, the acknowledgment feedback mode includes a semi-persistently scheduled (SPS) acknowledgment feedback mode. In some cases, the acknowledgment feedback mode includes: a first acknowledgment feedback mode in which the NACK feedback and the ACK feedback are transmitted, wherein the NACK feedback is transmitted with the mechanism to increase reliability relative to the ACK feedback; or a second acknowledgment feedback mode in which only the NACK feedback is transmitted with the mechanism. In some cases, the mechanism to increase reliability includes at least one of: increased transmission power; the use of at least one of different time resources or frequency resources; transmitting the NACK feedback with repetition; or transmitting the NACK feedback on an uplink channel without multiplexing other signals. In some cases, the repetition includes at least one of: repetition in space using multiple beams, repetition in frequency, or repetition in time. In some cases, the means for communicating with the UE in accordance with the acknowledgment feedback mode includes: means for generating the NACK feedback for transmission to the UE; or means for monitoring for the NACK feedback transmitted from the UE in accordance with the acknowledgment feedback mode.

In some examples, the signaling includes a DCI with a field indicating the acknowledgment feedback mode. In some cases, the DCI may schedule an uplink transmission or schedule a downlink transmission. In some cases, the signaling includes a medium access control (MAC) control element (CE) or radio resource control (RRC) message. In some cases, the RRC message includes: a RRC setup message, a RRC reconfiguration message, a RRC reestablishment message, or a RRC resume message. In some cases, the apparatus for wireless communications by the network entity includes means for obtaining, from the UE, a request for the acknowledgment feedback mode, wherein the signaling is outputted after obtaining the request.

In some examples, an apparatus for wireless communications by a UE includes: an interface configured to obtain signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and a processing system configured to communicate with the network entity in accordance with the indicated acknowledgment feedback mode. In some cases, the acknowledgment feedback mode includes a semi-persistently scheduled (SPS) acknowledgment feedback mode. In some cases, the acknowledgment feedback mode includes: a first acknowledgment feedback mode in which the NACK feedback and the ACK feedback are transmitted, wherein the NACK feedback is transmitted with the mechanism to increase reliability relative to the ACK feedback; or a second acknowledgment feedback mode in which only the NACK feedback is transmitted with the mechanism. In some cases, the mechanism to increase reliability includes at least one of: increased transmission power; the use of at least one of different time resources or frequency resources; transmitting the NACK feedback with repetition; or transmitting the NACK feedback on an uplink channel without multiplexing other signals therein. In some cases, the repetition includes at least one of: repetition in space using multiple beams, repetition in frequency, or repetition in time. In some cases, the processing system communicates with the network entity in accordance with the acknowledgment feedback mode by generating the NACK feedback for transmission to the network entity; or monitoring for the NACK feedback transmitted from the network entity in accordance with the acknowledgment feedback mode.

In some examples, the signaling includes a DCI with a field indicating the acknowledgment feedback mode. In some cases, the DCI may schedule an uplink transmission or schedule a downlink transmission. In some cases, the signaling includes a medium access control (MAC) control element (CE) or radio resource control (RRC) message. In some cases, the RRC message includes a: a RRC setup message, a RRC reconfiguration message, a RRC reestablishment message, or a RRC resume message. In some cases, the interface that is configured to obtain signaling from a network entity is further configured to output, for transmission to the network entity, a request for the acknowledgment feedback mode, where the signaling is obtained after outputting the request.

In some examples, an apparatus for wireless communications by a network entity includes: an interface configured to output, for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and a processing system configured to communicate with the UE in accordance with the indicated acknowledgment feedback mode. In some cases, the acknowledgment feedback mode includes a semi-persistently scheduled (SPS) acknowledgment feedback mode. In some cases, the acknowledgment feedback mode includes: a first acknowledgment feedback mode in which the NACK feedback and the ACK feedback are transmitted, wherein the NACK feedback is transmitted with the mechanism to increase reliability relative to the ACK feedback; or a second acknowledgment feedback mode in which only the NACK feedback is transmitted with the mechanism. In some cases, the mechanism to increase reliability includes at least one of: increased transmission power; the use of at least one of different time resources or frequency resources; transmitting the NACK feedback with repetition; or transmitting the NACK feedback on an uplink channel without multiplexing other signals. In some cases, the repetition includes at least one of: repetition in space using multiple beams, repetition in frequency, or repetition in time.

In some examples, the processing system communicates with the UE in accordance with the acknowledgment feedback mode by: generating the NACK feedback for transmission to the UE; or monitoring for the NACK feedback transmitted from the UE in accordance with the acknowledgment feedback mode. In some cases, the signaling includes a DCI with a field indicating the acknowledgment feedback mode. In some cases, the DCI may schedule an uplink transmission or schedule a downlink transmission. In some cases, the signaling includes a medium access control (MAC) control element (CE) or radio resource control (RRC) message. In some cases, the RRC message includes: a RRC setup message, a RRC reconfiguration message, a RRC reestablishment message, or a RRC resume message. In some cases, the interface that is configured to output, for transmission to a UE, signaling is further configured to obtain, from the UE, a request for the acknowledgment feedback mode, wherein the signaling is outputted after obtaining the request.

In some examples, a UE includes: at least one antenna; an interface configured to obtain, via the at least one antenna, signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and a processing system configured to communicate, via the at least one antenna, with the network entity in accordance with the indicated acknowledgment feedback mode.

In some examples, a network entity includes: at least one antenna; an interface configured to output, via the at least one antenna and for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and a processing system configured to communicate, via the at least one antenna, with the UE in accordance with the indicated acknowledgment feedback mode.

In some examples, a computer-readable medium for wireless communications includes codes executable to: obtain signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and communicate with the network entity in accordance with the indicated acknowledgment feedback mode.

In some examples, a computer-readable medium for wireless communications includes codes executable to: output, for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and communicate with the UE in accordance with the indicated acknowledgment feedback mode.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may include a single instruction, or many instructions, and may be distributed over several different code segments, among different programs, and across multiple storage media. The computer-readable media may include a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may include non-transitory computer-readable media (e.g., tangible media). In addition, for other aspects computer-readable media may include transitory computer- readable media (e.g., a signal). Combinations of the above should also be included within the scope of computer-readable media.

Thus, certain aspects may include a computer program product for performing the operations presented herein. For example, such a computer program product may include a computer-readable medium having instructions stored (and/or encoded) thereon, the instructions being executable by one or more processors to perform any of the methods discussed herein.

Further, it should be appreciated that modules and/or other appropriate means for performing the methods and techniques described herein can be downloaded and/or otherwise obtained by a user terminal and/or BS as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or BS can obtain the various methods upon coupling or providing the storage means to the device. Moreover, any other suitable technique for providing the methods and techniques described herein to a device can be utilized.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A method of wireless communication, comprising:
receiving, by a user equipment (UE) from a base station (BS), a negative acknowledgement (NACK) transmission configuration;
receiving, by the UE from the BS, a data transmission; and
transmitting, by the UE to the BS, a physical uplink control channel (PUCCH) signal including a NACK for the data transmission based on the received NACK transmission configuration.

2. The method of claim 1, wherein the receiving the NACK transmission configuration includes:
receiving, by the UE from the BS, a flag indicating whether to increase a transmit power of the PUCCH signal when the PUCCH signal includes the NACK.

3. The method of claim 1, wherein the receiving the NACK transmission configuration includes:
receiving, by the UE from the BS, a transmit power parameter.

4. The method of claim 1, wherein the receiving the NACK transmission configuration includes:
receiving, by the UE from the BS, a plurality of transmit power parameters, wherein each transmit power parameter of the plurality of transmit power parameters is associated with a logical channel of a plurality of logical channels.

5. The method of claim 4, wherein the transmitting includes:
transmitting, by the UE to the BS, the PUCCH signal using a first transmit power parameter of the plurality of transmit power parameters based on a logical channel associated with the data transmission.

6. The method of claim 1, wherein the receiving the NACK transmission configuration includes:
receiving, by the UE from the BS, a plurality of transmit power parameters, wherein each transmit power parameter of the plurality of transmit power parameters is associated with a PUCCH format of a plurality of PUCCH formats, wherein the plurality of PUCCH formats include at least one of a PUCCH format 0, a PUCCH format 1, a PUCCH format 2, a PUCCH format 3, or a PUCCH format 4.

7. The method of claim 6, wherein the transmitting further includes:
transmitting, by the UE to the BS, the PUCCH signal using a first transmit power parameter of the plurality of transmit power parameters based on a PUCCH format of the PUCCH signal.

8. The method of claim 1, wherein the receiving the NACK transmission configuration includes:
receiving, by the UE from the BS, a PUCCH configuration including:
a first transmit power offset for a non-NACK transmission; and
the NACK transmission configuration including a second transmit power offset different from the first transmit power offset.

9. The method of claim 8, wherein the second transmit power offset corresponds to a higher transmit power than the first transmit power offset.

10. The method of claim 1, wherein the receiving the NACK transmission configuration includes:
receiving, by the UE from the BS, a PUCCH configuration including:
a first target received power for a non-NACK transmission; and
the NACK transmission configuration including a second target received power different from the first target received power.

11. The method of claim 10, wherein the second target received power is greater than the first target received power.

12. The method of claim 1, wherein the receiving the NACK transmission configuration includes:
receiving, by the UE from the BS, at least one of a NACK-specific PUCCH format 0 configuration, a NACK-specific PUCCH format 1 configuration, a NACK-specific PUCCH format 2 configuration, a NACK-specific PUCCH format 3 configuration, or a NACK-specific PUCCH format 4 configuration.

13. The method of claim 1, wherein the receiving the NACK transmission configuration includes:
receiving, by the UE from the BS, a beam parameter indicating a number of transmission beams.

14. The method of claim 13, wherein the transmitting includes:
transmitting, by the UE to the BS, a first PUCCH signal including the NACK in a first beam direction; and
transmitting, by the UE to the BS based on the beam parameter, a second PUCCH signal including the NACK in a second beam direction different from the first beam direction.

15. The method of claim 14, wherein the beam parameter further indicates a beam sequence including the first beam direction and the second beam direction.

16. The method of claim 14, wherein the transmitting includes:
transmitting, by the UE to the BS, the first PUCCH signal in the first beam direction during a first time period; and
transmitting, by the UE to the BS, the second PUCCH signal in the second beam direction during a second time period different from the first time period.

17. The method of claim 14, wherein the transmitting includes:
transmitting, by the UE to the BS based on the beam parameter, the second PUCCH signal in the second beam direction simultaneously with the first PUCCH signal in the first beam direction.

18. The method of claim 1, wherein the receiving the NACK transmission configuration includes:
receiving, by the UE from the BS, a PUCCH configuration including:
a first resource allocation for a non-NACK transmission; and
the NACK transmission configuration including a second resource allocation different from the first resource allocation.

19-192. (canceled)

193. An apparatus for wireless communications by a user equipment (UE), comprising:
an interface configured to obtain signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and
a processing system configured to communicate with the network entity in accordance with the indicated acknowledgment feedback mode.

194. (canceled)

195. The apparatus of claim 193, wherein the acknowledgment feedback mode comprises:
a first acknowledgment feedback mode in which the NACK feedback and the ACK feedback are transmitted, wherein the NACK feedback is transmitted with the mechanism to increase reliability relative to the ACK feedback; or
a second acknowledgment feedback mode in which only the NACK feedback is transmitted with the mechanism.

196. The apparatus of claim 193, wherein the mechanism to increase reliability comprises at least one of:
increased transmission power;
the use of at least one of different time resources or frequency resources;
transmitting the NACK feedback with repetition; or
transmitting the NACK feedback on an uplink channel without multiplexing other signals therein.

197. The apparatus of claim 196, wherein the repetition comprises at least one of: repetition in space using multiple beams, repetition in frequency, or repetition in time.

198. The apparatus of claim 193, wherein the processing system communicates with the network entity in accordance with the acknowledgment feedback mode by:
generating the NACK feedback for transmission to the network entity; or
monitoring for the NACK feedback transmitted from the network entity in accordance with the acknowledgment feedback mode.

199. The apparatus of claim 193, wherein the signaling comprises a downlink control information (DCI) with a field indicating the acknowledgment feedback mode.

200. (canceled)

201. The apparatus of claim 193, wherein the signaling comprises a medium access control (MAC) control element (CE) or radio resource control (RRC) message.

202. The apparatus of claim 201, wherein the RRC message comprises at:
a RRC setup message, a RRC reconfiguration message, a RRC reestablishment message, or a RRC resume message.

203. The apparatus of claim 193, wherein the interface is further configured to:
output, for transmission to the network entity, a request for the acknowledgment feedback mode, wherein the signaling is obtained after outputting the request.

204. An apparatus for wireless communications by a network entity, comprising:
an interface configured to output, for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and
a processing system configured to communicate with the UE in accordance with the indicated acknowledgment feedback mode.

205. (canceled)

206. The apparatus of claim 204, wherein the acknowledgment feedback mode comprises:
a first acknowledgment feedback mode in which the NACK feedback and the ACK feedback are transmitted, wherein the NACK feedback is transmitted with the mechanism to increase reliability relative to the ACK feedback; or
a second acknowledgment feedback mode in which only the NACK feedback is transmitted with the mechanism.

207. The apparatus of claim 204, wherein the mechanism to increase reliability comprises at least one of:
increased transmission power;
the use of at least one of different time resources or frequency resources;
transmitting the NACK feedback with repetition; or
transmitting the NACK feedback on an uplink channel without multiplexing other signals.

208. The apparatus of claim 207, wherein the repetition comprises at least one of: repetition in space using multiple beams, repetition in frequency, or repetition in time.

209. The apparatus of claim 204, wherein the processing system communicates with the UE in accordance with the acknowledgment feedback mode by:
generating the NACK feedback for transmission to the UE; or
monitoring for the NACK feedback transmitted from the UE in accordance with the acknowledgment feedback mode.

210. The apparatus of claim 204, wherein the signaling comprises a downlink control information (DCI) with a field indicating the acknowledgment feedback mode.

211. (canceled)

212. The apparatus of claim 204, wherein the signaling comprises a medium access control (MAC) control element (CE) or radio resource control (RRC) message.

213. The apparatus of claim 212, wherein the RRC message comprises:
a RRC setup message, a RRC reconfiguration message, a RRC reestablishment message, or a RRC resume message.

214. The apparatus of claim 204, wherein the interface is further configured to:
obtain, from the UE, a request for the acknowledgment feedback mode, wherein the signaling is outputted after obtaining the request.

215. A user equipment (UE), comprising:
at least one antenna;
an interface configured to obtain, via the at least one antenna, signaling from a network entity indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and
a processing system configured to communicate, via the at least one antenna, with the network entity in accordance with the indicated acknowledgment feedback mode.

216. A network entity, comprising:
at least one antenna;
an interface configured to output, via the at least one antenna and for transmission to a user equipment (UE), signaling indicating an acknowledgment feedback mode in which negative acknowledgment (NACK) feedback is transmitted with a mechanism to increase reliability relative to positive acknowledgment (ACK) feedback transmitted in the acknowledgment feedback mode or a second acknowledgment feedback mode; and
a processing system configured to communicate, via the at least one antenna, with the UE in accordance with the indicated acknowledgment feedback mode.
